(19) United States
(12) Patent Application Publication
(10) Pub. No.: US 2022/0061273 A1
(43) Pub. Date: Mar. 3, 2022

(54) SYSTEM FOR ZONED-BASED SOLAR HEATING AND VENTILATION OF POULTRY STRUCTURES

(71) Applicant: John C. Wolf, II, Jacksonville, FL (US)

(72) Inventor: John C. Wolf, II, Jacksonville, FL (US)

(21) Appl. No.: 17/500,815

(22) Filed: Oct. 13, 2021

Related U.S. Application Data
(63) Continuation-in-part of application No. 16/444,336, filed on Jun. 18, 2019, now abandoned.
Application No. 16/444,336 is a continuation of application No. 15/831,105, filed on Dec. 4, 2017, now Pat. No. 10,321,665.
Application No. 15/831,105 is a continuation of application No. 14/599,163, filed on Jan. 16, 2015, now Pat. No. 9,848,586.
(60) Provisional application No. 61/927,991, filed on Jan. 16, 2014.

(51) Int. Cl. A01K 31/20; F24S 90/00; F24S 10/80; A01K 1/00; F24S 50/40; F24F 5/00; F24F 11/00

(52) U.S. Cl. CPC A01K 31/20; F24S 90/00; F24S 10/80; A01K 1/0047; F24S 50/40; Y02B 10/20; Y02P 60/12; Y02E 10/44; F24F 2011/0002; Y02A 30/272; Y02P 60/52; Y02A 40/76; F24F 2005/0064

(57) ABSTRACT

A system of solar thermal collectors and an HVAC controller draw heated air through a solar thermal absorbing needle-punched propylene geotextile with limited permeability to air flow, into the interior of poultry livestock house. In various embodiments, the poultry livestock house is divided into zones. Groups of collectors are joined with breather holes on opposite sides of the collectors and solid sides on the ends of each group. Groups of collectors serve each zone of the poultry livestock house. In an embodiment of the system the Environmental Optimization System (“EOS”) provides a system for the intelligent control and monitoring the broiler poultry livestock structure environment through the utilization of a variety of environmental and livestock behavior sensors, apparatus for controlling the thermal collection and existing interior heating/air conditioning/ventilation (“HVAC”) systems, and Internet or cloud based intelligent control and monitoring capabilities of the system. In various embodiments central sensor data aggregation is utilized to provide improved optimization control for livestock zones within individual structures based on data from multiple structures.

### RELATED APPLICATIONS

This application is a continuation-in-part of U.S. patent application Ser. No. 16/444,336 filed on Jun. 18, 2019 which is a continuation of application Ser. No. 15/831,105 filed on Dec. 4, 2017, which is a continuation of U.S. patent application Ser. No. 14/599,163 filed on Jan. 16, 2015 and claims the benefit of these applications as well as U.S. provisional application 61/927,991 filed on Jan. 16, 2014. The above identified applications are incorporated herein in their entirety.

### FIELD OF THE INVENTION

The present invention generally relates to the field of environmental control.

### BACKGROUND

Animals and plants can tolerate only a limited range of environmental conditions. Depending on the species, the ideal range of environmental conditions may be very narrow, particularly during early development. Certain livestock, such as poultry, are commonly housed in a structure with controlled conditions in order to provide the optimal environment for productive and healthy growth. A critical factor for determining the productivity for poultry houses is known as the speed to weight factor, or the time it takes for the poultry to reach the target weight.

Controlling body temperature, or thermoregulation, varies considerably between species of animals, sometimes identified as “warm-blooded”. Young poultry, or chicks for example, have very limited ability to control their own body temperature during the first weeks of development after hatching. To mitigate this problem, when poultry chicks are raised after hatching, the chicks are commonly housed in large structures with ventilation and heating apparatus which is designed to keep the interior at or near 90° F. and to minimize interior humidity. The youngest chicks are sometimes raised in groups, or broods, confined to circular areas in the house known as brooding rings, underneath radiant heat sources known as radiant brooders or pancake brooders.

Environmental humidity has several deleterious effects on the development and health of the chicks in poultry houses. When relative humidity increases, the evaporative capacity of the air decreases. As chicks get older, they are able to lower their body temperature by evaporative heat loss from their lungs. If the chicks overheat, they begin to pant to reduce their core body temperature. If unable to do so, they expire from heat stress. Similarly, the floor of the poultry house, or litter, may become soaked in detritus, including bird waste. If not allowed to dry by evaporation this also negatively affects poultry health. Bacterial growth in the wet litter is known to be the most common source of ammonia gas in poultry houses.

Ammonia gas in a poultry house has been demonstrated to negatively affect chick health and growth. Ventilation of the structure is the common means to reduce ammonia, but this also decreases temperature, which is problematic during cooler months and necessitates frequent use of heating sources and associated costly energy resources. Venting with fresh air is commonly accomplished at fixed intervals for a structure and supplemental heat is provided to account for the infusion of cold air. This process can cause unwanted fluctuations in temperature in the interior of the structure and does not provide any dynamic ability to control interior ammonia.

In the United States, poultry livestock are primarily farmed in the southeastern states, from eastern Texas to North Carolina. Farming is year-round in all locations. Widely varying local weather is common throughout the southeast United States and sudden changes in weather are common in the spring and fall. This further complicates environmental control of the poultry houses. As mentioned above, during winter months, cold air vented into houses often requires considerable increase in the interior heating for houses with associated fuel costs.

Modern poultry house ventilation systems typically use very large “tunnel fans” which are extremely noisy, causing additional stress and negative health impact on the chicks growing in the poultry house.

Heat, relative humidity, ammonia and noise are several of the factors that can negatively impact both the health and market worthiness of the poultry, as well as the speed to weight for the poultry, or productivity of the house.

Due to the complexity of controlling numerous inputs and monitoring of potentially numerous conditions of poultry house environments, historically the conditions have been controlled manually by the poultry farmer, with warning indicators of extreme conditions. Computerized or automatic control systems have been used with varying degrees of success for several years. Yet numerous unsolved problems remain, including the reduction of energy use for heating and more reliable and effective ways of maintaining a balance of various environmental factors to optimize the conditions for the livestock within the housing structure.

### SUMMARY

Various aspects of the system and method disclosed herein, coined the Environmental Optimization System (“EOS”), address the problems of closed livestock structure environmental control and monitoring. Among these are the integration of an automatic dynamically controlled solar thermal collection device, dynamic control of the fan speed venting collected hot air from the collector into the house, dynamic control for ventilation of the structure, integration of the solar collector control with the house HVAC system. In addition, aggregated collection of sensor output from one or more livestock houses and housing locations into a cloud-based data server system, cloud based real-time monitoring of sensor systems, livestock behavior sensors as input to the control system and predictive control of the environmental apparatus. The benefits of the disclosed system include the dynamic ability to adjust house ventilation while maintaining optimal temperature in the house obtaining ideal ammonia levels—which directly impacts the speed to weight factor measure of house productivity.

Various embodiments for the EOS system include a variety of sensor systems which depend on the needs of a particular installation. Sensor systems may include exterior ambient temperature sensors, structure interior temperature sensors, thermal collection space temperature sensors, ventilation inlet and outlet temperature sensors, ammonia concentration sensors, CO₂ concentration sensors, relative humidity sensors, ultrasonic and infrared motion sensors, sound level sensors, microphones, video cameras, thermal imaging cameras and sunlight sensors.

In certain embodiments, solar thermal collection panels affixed to either the roofs or sun facing exterior walls of the livestock structures collect thermal energy in enclosed exterior spaces abutting the structure. The panel enclosures are controlled by the EOS system to either vent collected hot air into the structure interior, or opening vents on the top and bottom of the panel enclosure which allows unheated air to vent into the house, or to act as a thermal barrier from incident sunlight, by not trapping heat against the house. In various embodiments, the collection panel's orientation to the incident angle of the sun may be automatically adjusted by the EOS system. Temperature, humidity, sunlight and other sensors located on the exterior of the solar collection unit, in the interior of the solar unit at the house inlet vent and in the interior of the poultry house (including ammonia concentration sensors) are used by the EOS to control the solar collection air circulation, panel orientation, vent and vent fan controls. In various embodiments, the solar collection component utilizes Transpired Solar Collector (“TSC”) panels for efficient thermal collection.

In certain embodiments, livestock behavior sensors may be integrated into the EOS system to assist in measuring environment impact on the housed livestock and dynamically control the system to optimize healthy and productive conditions. Behavior may be monitored and measured by motion sensors, live video feeds, thermal imaging cameras and digital image analysis for motion and livestock patterns known to indicate healthy or unhealthy conditions. Digital analysis of thermal imaging can be used to determine thermal distribution in the house as well as the body heat and distribution of livestock in the house. Sound level sensors or microphones coupled with digital signal analysis can be used to measure livestock distress, healthy livestock (poultry chicks making soft “cheeping” sound) and stressful background noises. In certain embodiments large numbers of spatially deployed sensors throughout a facility may be implemented using a technology such as Bluetooth LE.

In certain embodiments, sensor readings from the EOS, including sensors related to measuring livestock behavior and live video, are sent from the poultry house to the Internet “cloud” for aggregation into a database used for tracking the system performance. The EOS database may be hosted in the cloud or on a dedicated server. In various embodiments sensors are networked together for a given facility by wireless data transmission such as Wi-Fi or Zigbee. In various embodiments, data from multiple sensors is taken as inputs for a controller which utilizes an optimization strategy to maintain ideal environmental conditions, which is measured by both the environment metrics known to be optimal and by the actual livestock behavior and growth metrics. The outputs of the controller include the controlled vents and fans. Examples of optimization strategies in various embodiments includes fuzzy control, fuzzy logic, decomposition into 2×2 control arrays, genetic algorithms, and multivariate regression. In other embodiments, the system is operated based on empirically derived and manually set control points, for example where optimization is performed manually by the operator of the system based upon observations of the particular livestock being raised demonstrating the effect of the given environmental conditions.

In certain embodiments, data from the EOS system hosted in an Internet cloud system is available for remote monitoring. The EOS data is utilized to perform the optimization control which is sent back from the system to the poultry house ventilation and fan controllers as described above. In various embodiments, the EOS performs analytics on the aggregated data from one or more poultry houses, which analytic information is available to system operators and livestock production staff. Such information may be presented as data log files for the sensors, or graphically and may include one or more environmental, behavior, or production metrics.

In various embodiments, weather prediction data for poultry house locations available from Internet sources is incorporated into the EOS system. This will aid in the predictive control of the poultry house systems to reduce the effect of rapidly changing ambient weather conditions on the interior house environment.

In certain embodiments, the EOS system utilizes machine learning to improve predictive environment control and operation control of the poultry house systems.

In various embodiments, the transpired solar collector (“TSC”) enclosure is utilized as a solar shade when the exterior ambient temperature is high, such that air is vented through the enclosure and the external wall of the house remains relatively cool.

In various embodiments, hot air from the enclosure may be vented into a thermal storage volume, such as an attic of the house during daytime, and then pumped into the house at nighttime to save heating costs at night. This process is controlled by the EOS.

Embodiments of the system use a shallow box behind an optimized permeable geotextile solar collection absorption material to maximize the temperature gradient developed by the collector and more efficiently and rapidly heat the air drawn into and through the collector body by controllable fans. To allow free flow of air between adjacent collectors and equalize flow pressure while maintaining structural strength, collector units utilize interior brace supports and end structures with breather hole openings, which increase the torsional and shear strength of the collector.

Alternative embodiments of the system use a shallow box behind a permeable textile transpired solar collection absorption material to maximize the temperature gradient developed by the collector and more efficiently and rapidly heat the air passing into and through the collector body. The permeable textile is selectable by empirical evaluations in various environmental conditions as detailed below. To allow free flow of air between adjacent collectors and equalize flow pressure while maintaining structural strength, collector units utilize interior brace supports and end structures with breather hole openings which increase the torsional and shear strength of the collector without creating a differential pressure between collectors. The modular design for the collectors with breather holes also allows for embodiments with consolidated external ducting and forced air (fan) components.

In an alternative embodiment using the collector boxes as above, the individual collector units are modularly designed for simple assembly and transportation, as well as structural durability for surviving extreme weather events. In optional configurations, the assembled unit operational angle for incident exposure to the sun is modifiable by the manufacturer, by the installer, by an operator, or dynamically during operation of the collector.

### BRIEF DESCRIPTION OF THE DRAWINGS

FIG. 1 depicts an overview of an exemplary EOS system.

FIG. 2 is a block diagram showing the components of an exemplary EOS system.

FIG. 3 is a flow chart showing an embodiment of the operation flow for solar collector panel system control.

FIG. 3A is a chart showing an example use of predictive control for interior poultry house environment.

FIG. 3B shows 3 diagrams which depict configurations of the solar collector during various modes of operation.

FIG. 4 is a flow chart showing an embodiment of the operation of data aggregation from poultry houses and the performance of analytics for adjusting environmental control.

FIG. 5 shows an embodiment of a remote EOS monitor primary user interface.

FIG. 6 shows an embodiment of a remote EOS video feed user interface.

FIG. 7 shows is an embodiment of a remote EOS analytics monitor for environment sensors.

FIG. 8 shows a diagram of an embodiment utilizing a thermal storage volume.

FIG. 9 is a flow chart showing the operation of enclosure venting and heat storage processes controlled by EOS.

FIG. 10 shows a photograph of an alternate embodiment of a single collector module with a shallow collector box and permeable textile—a woven, needle-punched polypropylene material.

FIG. 11A-B show perspective views from the front and back of an alternative embodiment collector without its heat absorbing covering.

FIG. 12A-B show left and right views of an alternative embodiment collector.

FIG. 13A-B show the front and back of an alternative embodiment collector without its heat absorbing covering.

FIG. 14 is a close-up perspective view of a top and side edge of an alternative embodiment collector without its heat absorbing covering.

FIG. 15 shows a close-up view of an optimal collector absorber textile for an alternative embodiment.

FIG. 16 shows a diagrammatic side view of an alternative embodiment collector showing its anchor and ducting connection to an adjacent structure building.

FIG. 17 shows a diagrammatic side view of an alternative embodiment collector showing its anchor and ducting connection to an adjacent structure building.

FIGS. 18A-B show a diagrammatic view from the side and top of a poultry livestock structure zone configuration.

FIGS. 19A-B show a diagrammatic view from the side and top of a poultry livestock structure zone configuration.

FIG. 20 shows a sensor/system diagram of the sensors, alerts and control functions for zone-based EOS.

FIG. 21 shows a high-level view off the sensor and system outputs for zone-based EOS.

FIG. 22-25 show user interfaces panels for the EOS SaaS interface.

FIG. 26 shows a cross-section view of an alternative embodiment collector with ducting, damper and in-line forced air fan shown.

FIG. 27 shows a perspective rear view of an alternative embodiment collector with ducting, damper and in-line forced air fan shown.

FIG. 28 shows a perspective front above view of an alternative embodiment collector with ducting, damper and in-line forced air fan shown with exploded view of retaining frame and solar absorbing geotextile.

FIG. 29 shows a perspective front view of an alternative embodiment collector in a vertical orientation.

FIG. 30 shows a close of adjacent adjoining panels with the installation of a breather hole joint gasket.

FIG. 31 shows a four-collector unit implementation of vertically oriented panels.

FIG. 32 shows four sets of four-collector groups with ducting connecting the panels to a livestock house.

FIG. 33 shows a rear perspective view of an embodiment which is operator/installation single axis tilt adjustable in a low tilt angle configuration.

FIG. 34 shows a rear view of an embodiment which is operator/installation single axis tilt adjustable in a low tilt angle configuration.

FIG. 35 shows a rear perspective view of an embodiment which is operator/installation single axis tilt adjustable in a high tilt angle configuration.

FIG. 36 shows a side view of a dynamically adjustable linear actuator controlled single axis tilt adjustable collector unit.

### DETAILED DESCRIPTION

In an exemplary embodiment, an Environmental Optimization System (“EOS”) provides a system for the intelligent control and monitoring of a poultry house environment and livestock through the utilization of a solar thermal collection system, a variety of environmental sensors, apparatus for controlling the thermal collection and existing interior heating/air conditioning/ventilation (“HVAC”) systems and Internet or “cloud” based intelligent control and monitoring capability of the system.

Other exemplary applications include embodiments in which EOS is utilized for residential and greenhouse or other housed agriculture environmental control. Various residential and agricultural embodiments include solar thermal collection components.

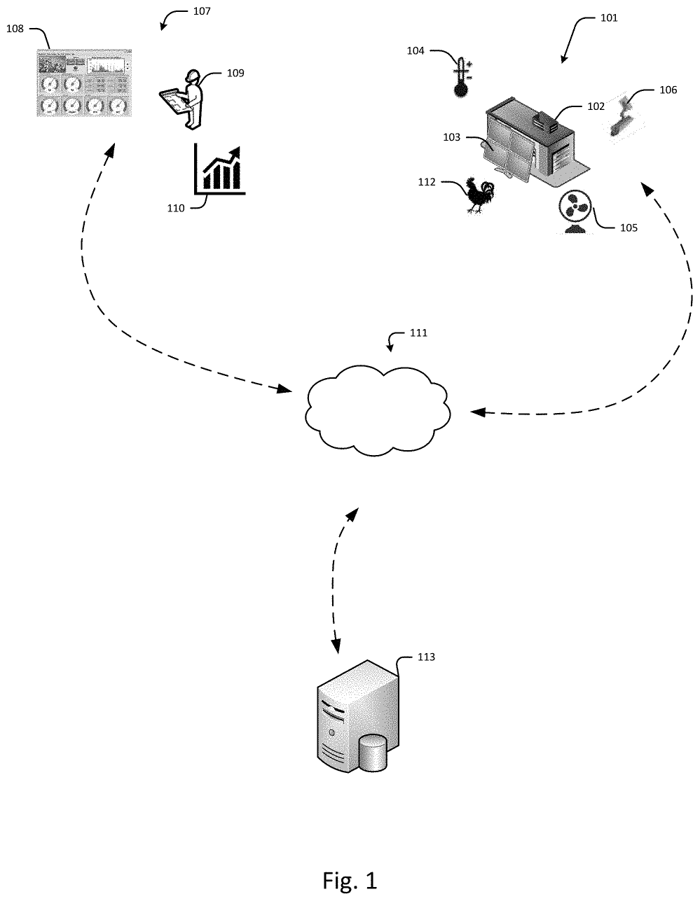

FIG. 1 shows an overview of an exemplary embodiment of an EOS system. In this embodiment, the controlled environment is the interior of a livestock structure 102, specifically one for raising poultry chicks 112. The poultry housing location 101 includes sensor systems 104, a dynamic solar thermal collector 103, thermal collector ventilation fans 105 and video monitors 106.

The EOS in this embodiment includes capabilities for remote monitoring 107 of the system sensors and video 108 by the facility operator 109, as well as analytics of the environmental conditions, livestock behavior production output 110. Data from the livestock environment 101 by uplink to the Internet (cloud) 111. Control, access, storage analytics may be hosted in the cloud 111 or in an offsite server system 113.

In certain embodiments the solar thermal collector 103 is a fabricated transpired solar collector (“TSC”) with EOS control of thermal ventilation and the angle of incidence of the solar panel to the sun. The incident angle of the sun to the solar collection surface may be adjusted by modifying the elevation angle of a normal to the solar collection surface by vertical tilt, or by adjusting the radial angle of incidence by rotational adjustments of the solar facing surface.

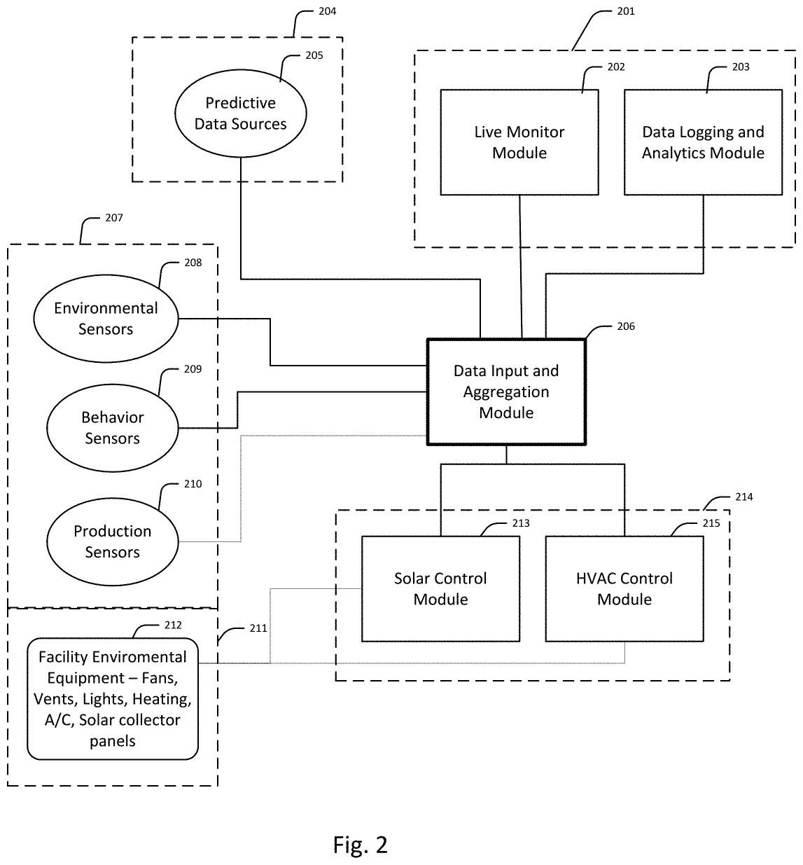

An embodiment of EOS control and data monitoring modules is shown in FIG. 2. Data sources include on-site sensor systems 207 cloud-based information 204, including predictive data 205, such as weather prediction information from an Internet source such as weather.com. On-site sensor systems 207 include environmental sensors 208 such as interior and ambient exterior temperature, interior CO₂ concentration, ammonia concentration, relative humidity sound level. Livestock behavior sensors 209 include motion detectors, video, thermal imaging, audio filtered for appropriate livestock frequencies, digital video analysis of livestock patterns, motion detection thermal distribution. On-site production sensors 210 in various embodiments may include sensors measuring livestock feed and water consumption, livestock weight and the speed to weight, or days of production to desired production weight.

The EOS system in various embodiments includes various data collection and processing aggregation modules 201 206 214. The primary data collection module 206 receives onsite 207 and offsite inputs 204 and sends output as the system directs, to the control modules 214 and the data monitor, logging and analytics modules 201. Data monitoring includes the live video feed, which is provided through the cloud 202 along with other logged 203 and live sensor data. Controller outputs are sent from the primary module to the solar collection control module and the facility HVAC control module. The EOS system operates in various embodiments by an integrated control of the solar thermal collection and ventilation and HVAC apparatus, including either forced air or radiant heaters 212, which are on-site at the poultry house livestock facility 211.

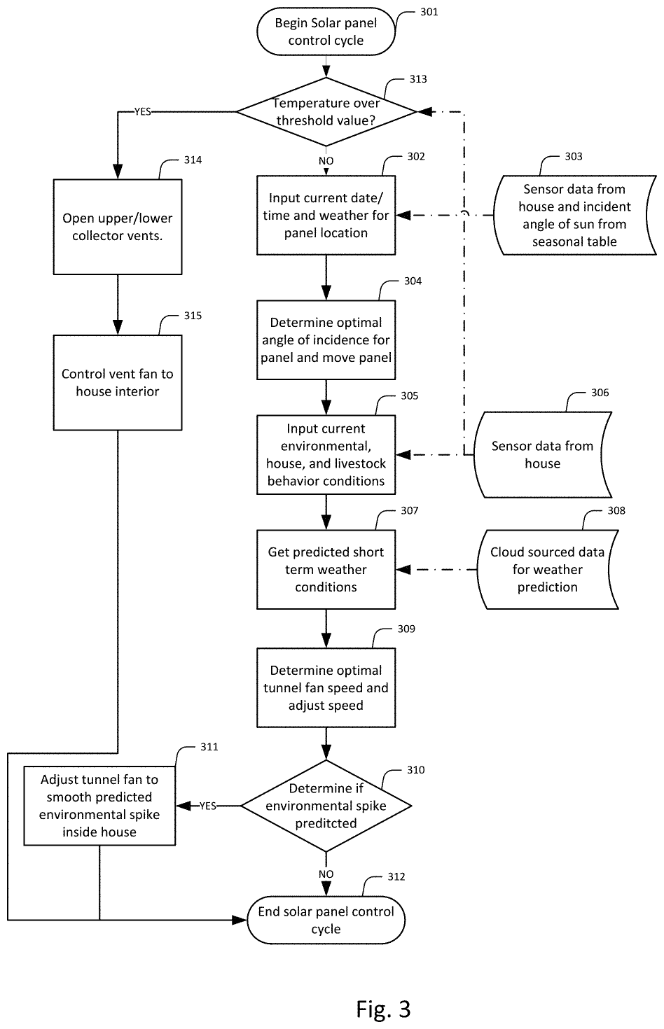

In various embodiments, a solar thermal collection apparatus is used as a controlled component by the EOS. An embodiment of solar thermal collection control operation is shown by flow chart in FIG. 3. In the shown embodiment, the collector control is initiated 301, before the control system receives various sensors. In certain embodiments, the solar collector is used as either a thermal insulator during high ambient temperature conditions, or to vent unheated fresh air into the house. The EOS controls this by opening collection system vents 314, on the top and bottom of the collector, when the ambient exterior temperature is above a threshold value 313. When indicated by the EOS to vent fresh air into the house (such as during high ammonia detection), air bypassing the solar collection panel is vented into the house 315. In certain embodiments, the collection panel may be moved or adjusted 304 according to the incident angle of the sun according to date (season), time of day 302 and the location of the house (latitude/longitude) according to data from look-up tables available through the cloud 303. After optimizing the incident angle 304, sensor information 306 is received by the system 305, including in various embodiments, CO₂ concentration, ammonia concentration, interior and exterior temperature, sunlight, relative humidity, interior sound level, thermal distribution livestock distribution and movement. In various embodiments, weather prediction data 308 for the house location is provided from cloud-based sources, particularly short term temperature predictions 307. In various embodiments, a fan in certain embodiments a tunnel fan, is used intermittently and a varying speeds, according to the controller 309 to raise house interior temperature by venting the thermal collection of fresh air into the interior of the house. If the system receives input indicating an impending spike drop in ambient temperature 310, the system may adjust or initiate an early start for the vent fan 311. The control cycle then completes 312 and is run periodically according to EOS operation.

FIG. 3A shows a time based 303A graph 301A of the interior and exterior house temperatures 302A and the effectiveness of EOS predictive control anticipating sudden temperature drops. In this graph, the solid line 304A represents exterior ambient temperature. If the EOS receives prediction data that the ambient temperature is going to have a sudden drop 311A during sunlight hours to a temperature below the ideal range 305A , the collector controller closes its upper/lower vents (shown in FIG. 3B) and begins thermal collection early to vent into the house interior. Thus, instead of reacting late to the temperature sudden drop 310A, the EOS uses early thermal collection to keep the interior temperature within the ideal range 308A. In various embodiments, the EOS may make other dynamic predictive adjustments to environment systems to account for predicted changes in relative humidity, predicted severe inclement weather, or predictive information from nearby monitored EOS based facilities.

FIG. 3B shows 3 different configurations demonstrating operation of the solar collector component in various embodiments. During summer use with relatively low ambient temperatures 301B, when the sun 307B is at a higher angle on incidence to the panel 308B, the bottom component of the panel structure 311B extends away from the house structure. During this operation mode, the upper 304B and lower 319B panel vents remain closed fresh air passes through 315B the transpired solar collector 309B. A foam insulator and mount 306B is used for thermal isolation between the panel and house exterior wall. During winter operation of the panel 302B, the sun 318B is at a lower angle of incidence 317B the bottom component of the panel structure 312B retracts towards the house structure. During summer operation of the panel with high relative ambient temperature 303B, the upper 305B and lower 310B panel structure vents are opened, allowing fresh air in the upper vent 314B and lower vent 313B to bypass the solar collector, reducing the temperature of air vented into the structure. In various embodiments the EOS is used to adjust vent apparatus for balancing thermal control and measured ammonia concentration in the house. In various embodiments, the panel vents may be hinged vents, butterfly vents, or electric motor controlled vents, among other available options.

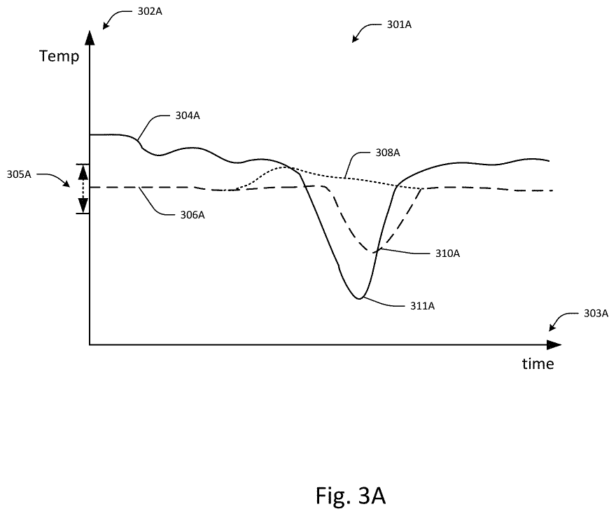

In various embodiments, data collection, monitoring analytics provide information relevant to the EOS controller and to system operators. In FIG. 4, this process is depicted by a flow chart. After data collection initiation 401, sensor information is received from house exterior sensors 402, which is sent to the EOS monitor user interface 406 to the EOS data archive 407. Similarly, interior sensor data received by the EOS 403 is sent to the archive component 407 and monitor user interface 406. Streaming (live) audio and video received by the system is uploaded to EOS 404 and available for the monitor user interface 406. Productivity data for the livestock is provided by sensors to the EOS 405 sent to the archive 407 for system aggregation 408. In various embodiments, the EOS computes analytics, for example trend analysis 408, which is sent to the user interface as requested 410. The collection cycle is completed 411 and periodically performed according to the EOS. In various embodiments, the EOS provides daily updates for operators to monitor the improvement in a house's speed to weight, a key measure of productivity.

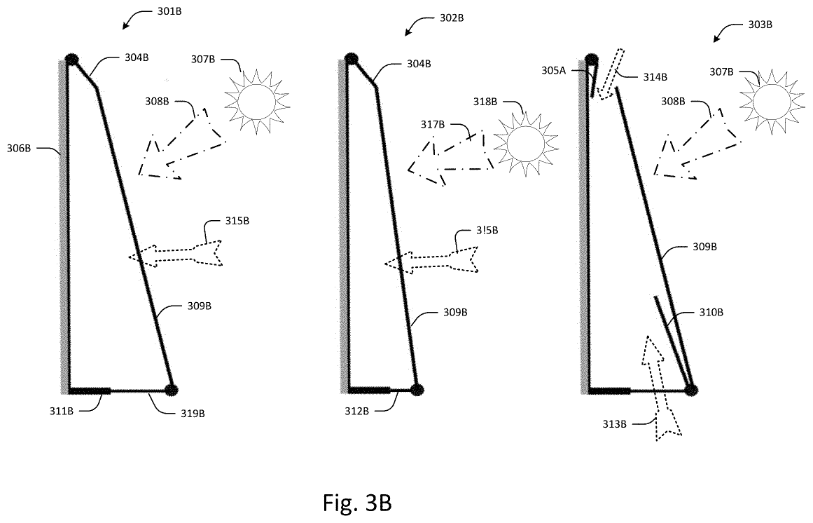

FIG. 5 shows an exemplary embodiment user interface 501 for EOS monitoring. Various embodiments contain different layouts and sensor information in the interface. In the shown embodiment, streaming video from the house 502 is shown along with an array of sensor gauges 503, digital gauges 505 historical (trend) data for relevant sensor information 504.

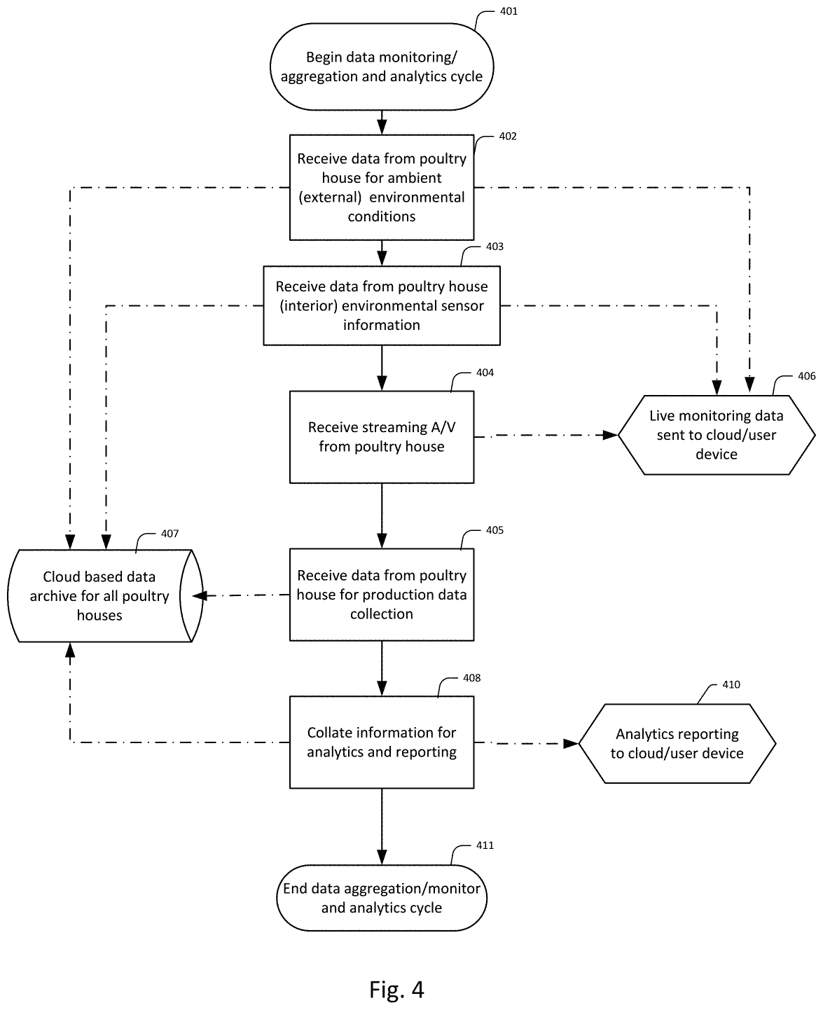

FIG. 6 shows an exemplary embodiment of the user interface 601 for EOS streaming video 602 from the house interior. Also available through the interface in certain embodiments is an interface for controlling the video feed 603 and a gauge showing livestock motion.

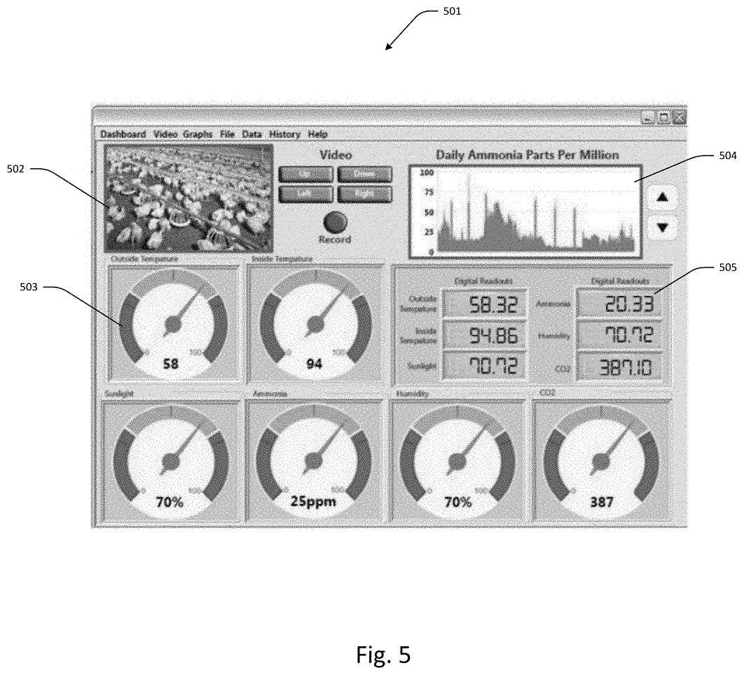

FIG. 7 shows an exemplary embodiment of the user interface 701 for EOS sensor historical data. In the shown embodiment, (time based) historical data is shown for sensor inputs such as external (ambient) temperature 702. The user interface also includes capabilities for users to show other analytics, to modify the data trends shown 704 and to manipulate the chart size 703.

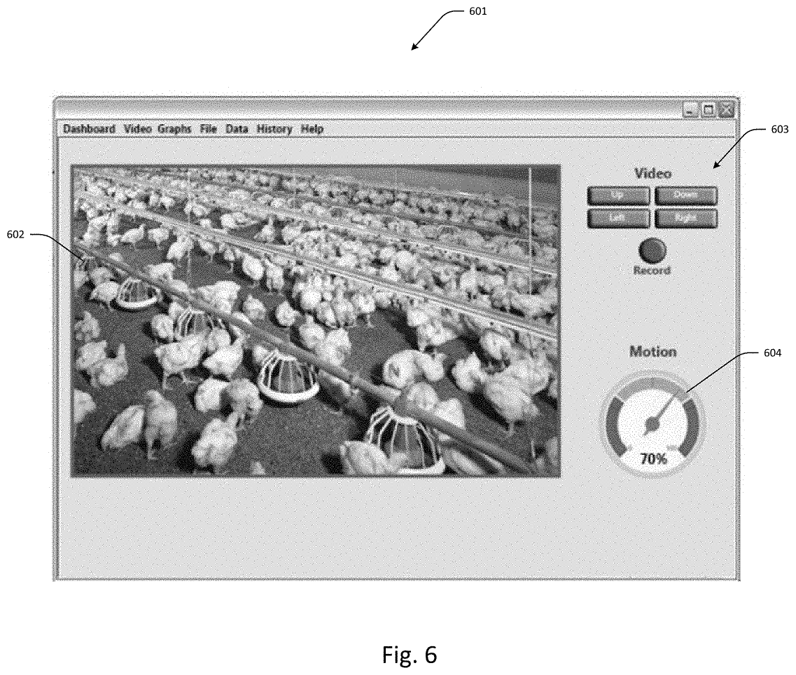

FIG. 8 shows a diagram of an embodiment of the system which includes a thermal or heat storage volume component. The poultry or residential house is shown 801 with the thermal storage volume in the “attic” 813 of the house 801. The components shown here include the solar collection enclosure 805 which collects solar 814 thermal energy which is collected by radiation 802 against the transpired solar collector 803. When unvented and in direct sunlight, experimental results have shown the enclosure internal air 804 temperature may rise over 80° F. above the ambient air temperature. During certain weather conditions and times of day, the heat accumulated in the collector enclosure may not be needed to heat the house interior. In the shown embodiment, this heat may be vented by a forced air blower fan 806 and directionally controlled by a duct 807 into 808 a storage volume 813 809, which in this embodiment is the attic of the house. During optimal conditions determined by the EOS control system, the stored heat is vented 811 to the house interior by a forced air blower 810.

In various embodiments, during certain times the house is vacant of poultry and the detritus from bottom of the house 813 is either cleaned out manually, or dried out during a clean out period. Experimental results show that under certain conditions, sun heated air in the solar enclosures may be 80° F. or more above the ambient air and with an 18% or more reduction in the ambient humidity of the outside air pulled through the solar collector. Given the amount of available heat, the EOS may be utilized in certain embodiments to raise house interior temperatures to the maximum temperature needed without supplemental fuel usage. Empirical analysis indicates a potential for a 20% to 50% or more reduction in clean out time of the house utilizing EOS controlled TSC solar enclosures depending on the time of the year and ambient temperature conditions.

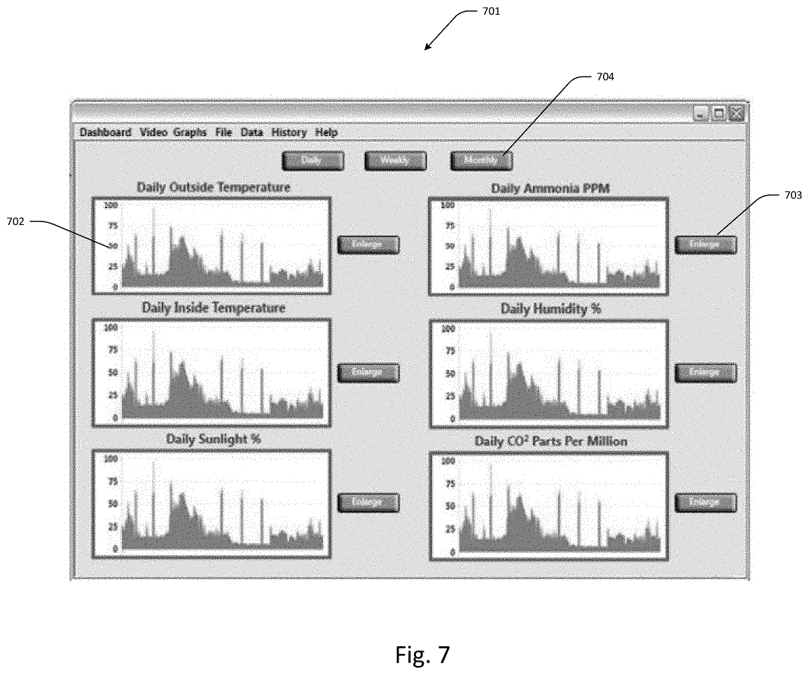

FIG. 9 shows a flow chart of the operation and control of an embodiment which includes a heat storage volume. Control of the system in this embodiment operates as a HVAC cycle 901 with environmental sensors 903 inputs and controlled vents and fans. During very warm weather conditions, the interior of the house may significantly exceed optimal conditions. During such conditions 915 in various embodiments, the EOS may be used to operate the solar collector as an exterior shade or solar insulator, by opening upper and lower vents on the collector 916 using the fans to push the heated air out of the solar collectors and into the outside environment. During cooler days, the enclosure is used to heat the house interior during conditions when the enclosure temperature is above the house interior 902 until the house reaches the optimal temperature 904. Under these conditions, the enclosure is vented to the interior of the house by a forced air fan 909, which is speed modulated 911 during the HVAC cycle to minimize electricity used by the fan and reduce the noise output.

Once the house optimal temperature is reached under these conditions 904-910 and according to the heat storage temperature 910 the enclosure heat may be diverted into the storage volume 913. Otherwise, the enclosure vents are closed and fan remains off while heat builds up in the enclosure 912.

When the exterior temperature drops at night and no heat is available from the enclosure 902-905, the stored heat (if hot enough 906) may be used to heat the house interior 908. Otherwise, residual enclosure heat may be used to build heat in storage, performing in some embodiments a thermal insulation effect for the interior.

For various embodiments the system components may be installed in combination with an existing structure HVAC system to minimize energy or fuel necessary to maintain the structure interior environment at optimal environmental conditions.

For various embodiments the system components are not directly integrated with the HVAC system, but the house ventilation cycle is modified according to experimental results of the EOS system. For example, a common current configuration for poultry housing is for the large high-volume tunnel fans to be programmed for periodic operation to remove ammonia from the house interior. A typical ventilation system may operate the tunnel(s) fan at full speed for perhaps 5 seconds every minute. In various embodiments, without directly integrating the EOS system with the current housing ventilation system, experimental results will demonstrate the amount of ammonia reduction provided by the EOS system, and the ventilation system may be reprogrammed or adjusted to reduce the ventilation tunnel fan operation for example to 5 seconds every 5 minutes. Since tunnel fan operation is extremely noisy and causes near windy conditions inside the house, the operation of the fans is detrimental to the health of the poultry. Hence minimizing the operation of the fans by the use of various embodiments of the EOS system improves the poultry health, reduces ammonia gasses in the interior environment, and decreases supplemental energy usage.

For various embodiments the system maintains a database of optimal structure interior temperatures and conditions with associated dates and times according to empirically determined optimal conditions during the growth life cycle of the livestock in the structure. For various embodiments the system may be manually reset to restart the growth cycle environment control, or may automatically reset according to sensor input indicating that a new growth cycle of livestock in the structure has begun.

For various embodiments, the solar collector components are designed for modular construction and may be configured with end collector units and center collector units such that each system has end units and at least one center unit, each unit having its own ventilation, fan, and sensor components based on the system needs and are electronically interconnected. In various embodiments, the system utilizes locally networked Supervisory Control and Data Acquisition (SCADA) controller and sensors, including Programmable Logic Controllers (PLC) to control individual fans, vents, dampers and other components, and to acquire sensor input from networked interior and exterior sensors. The SCADA network may be integrated with existing HVAC controller systems in various embodiments through the use of HVAC system Application Programming Interface (API) access to the existing HVAC system.

An alternative embodiment design for a solar collector unit is disclosed herein as an alternative embodiment which provides improvements in simplicity of construction, durability, and solar collector thermal efficiency in certain applications. This embodiment utilizes a shallow box which may be more optimally oriented to incident sunlight and provides for a smaller volume of air in the collector per unit of area for solar absorption and to improve the volumetric heating efficiency in certain applications. This alternate embodiment utilizes a selected woven polymer material as its solar radiation absorber with a textile weight of 5 oz/sq. yard. The material utilized, which is a type of geotextile, has several properties in addition to its thermal characteristics, which make it ideal. The solar radiation absorber fabric is resistant to UV degradation, highly durable, and tested as a geotextile under ASTM D5261. Embodiments suited to implementations under various environmental conditions may utilize other geotextile materials, including non-woven geotextiles, but generally with a minimum textile weight of 5 oz/sq. yard.

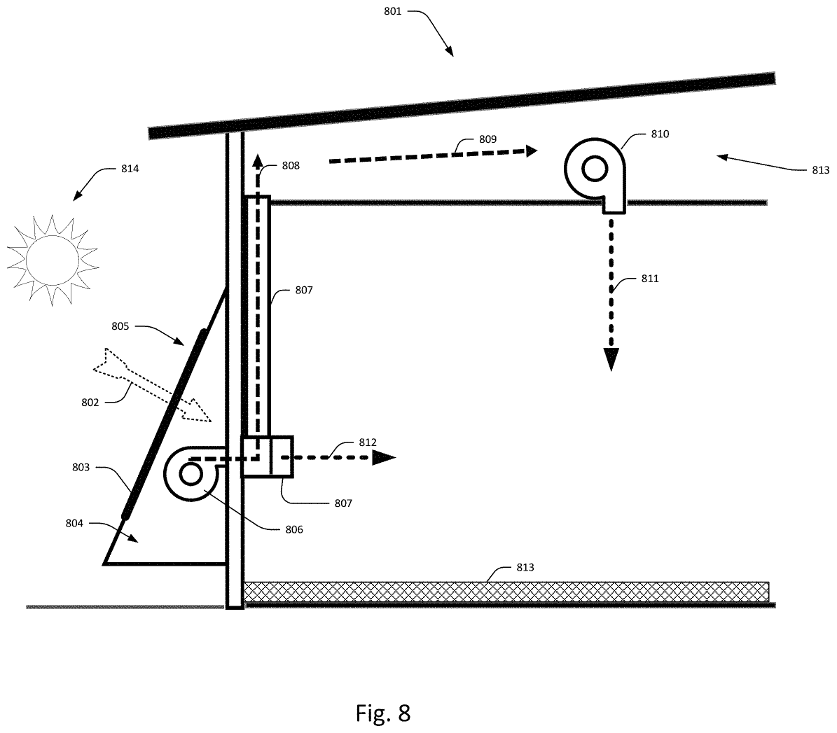

FIG. 10 is a photograph of a single collector configured as the alternative embodiment. Shown in the photograph is the collector body 1001 and solar radiation absorber fabric 1006, which acts as the transpired layer of the collector. The solar radiation absorber is as shown in this embodiment riveted to the collector body, providing for both rapid manufacturing, and potential simple replacement at the life end of the fabric. Not shown is a center brace underneath the fabric, which provides a structural framework and support for the collector and for the TSC geotextile absorber fabric and incorporates breather holes for the free flow of air between the sides of the collector body. Also shown in FIG. 10 is the collector absorber face plate 1002 which along with optional glazing tape fixes the absorber textile on the collector body sides 1020.

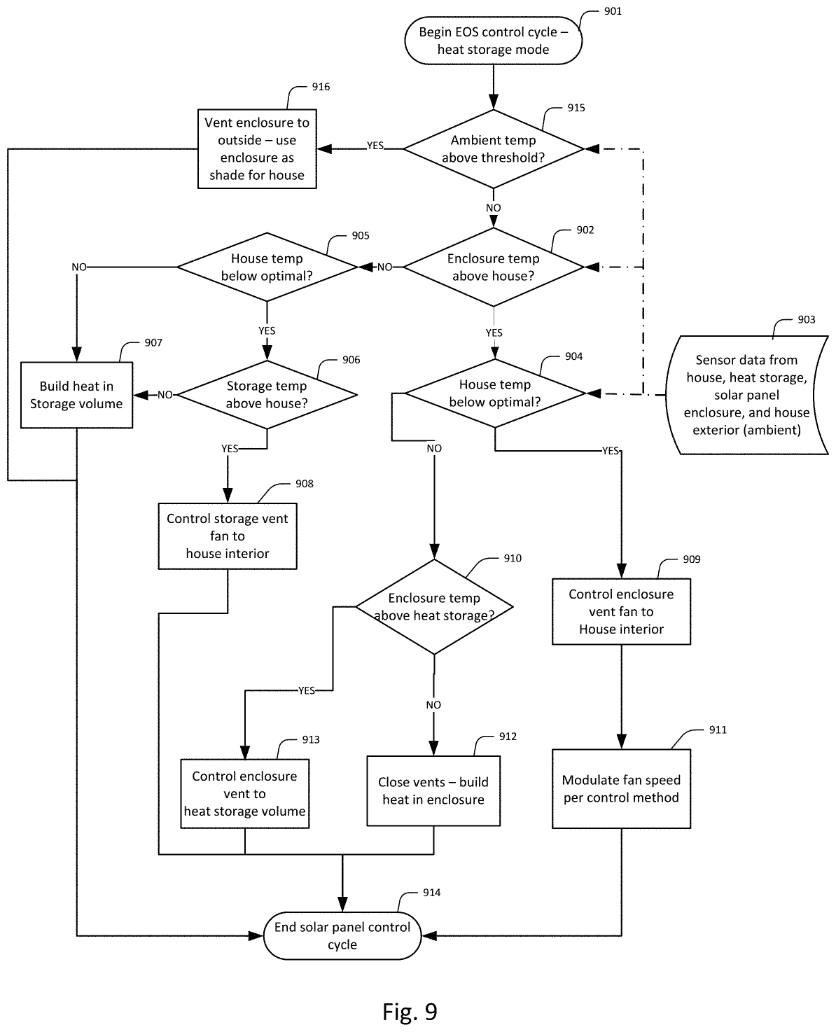

Perspective views of an embodiment of a single collector body 1001 and support frame is shown in FIG. 11A-B. The back view in FIG. 11A shows various components of the collector body, including the collector back 1012, support frame beams 1008 1009 and 1010, and collector frame abutment or joint edge or side 1004 with joint breather holes 1011. The support frame of the embodiment shown is configurable by the manufacturer to an angular position to reflect the optimum tilt angle for the thermal absorber geotextile towards the sun. As a general principal, a solar collector, including both thermal and photovoltaic collectors receive the maximum amount of solar radiation when the collector solar facing panel is perpendicular to position of the sun. Thus, when the incident angle θ is 90 degrees to the sun, the absorbed radiation is at its maximum and cos θ is a maximum value. The tilt angle of the panel to the ground is denoted as angle β. In previous work, maximizing cos θ for various tilt angles β has been computed analytically according to the date, time latitude and ground orientation of the collector installation, and has been determined experimentally with published The optimal angle is determined generally for southern exposure positioning of the collector near the appropriate side of a livestock house according to the latitude location of house. Previous work has been compiled and published by the National Renewable Energy Laboratory (NREL) for optimal fixed tilt angles of solar collectors at specific locations throughout the US. Optimal collector positioning for single axis and double axis tilt panels is also provided by NREL and is utilized for configurations of embodiments of those respective types. A feature of the embodiment is a minimum clearance off the ground 1012 of approximately 4 inches to prevent storm damage or necessary maintenance of the collector. In certain embodiments, a drain hole and plug are located at bottom of the collected to drain any water accumulation within the collector.

In FIG. 11B, various other features of the embodiment are apparent. These include the collector end 1020, the solar absorber retaining lip 1019, the output vent 1018, center support brace 1016, central support brace breather holes 1014 and support frame mount 1022. Shown in FIGS. 11A and 11B are an end unit collector embodiment. Center collector units include breather holes 1003 on each side of the collector frame 1004. In various embodiments with multiple collectors joined into modular groups of 2+ collectors, only a central collector may include an outlet duct. For example, in a group of 3 collectors joined into a unit, outlet ducting may be from each collector and joined behind the collectors by ducting, or only from the central collector. In such an embodiment for a single collector in a group with an outlet duct, the breather holes between all of the lateral collector spaces in the group allow for free air flow. Such an embodiment provides simpler and less expensive collector ducting.

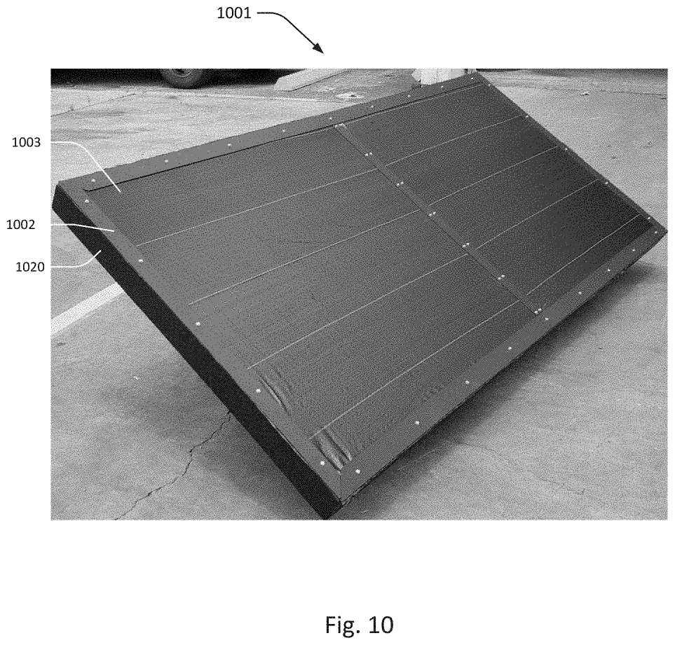

FIG. 12A and FIG. 12B show side views of the collector 1001 and various features and components of the embodiment. These include the collector frame bottom support 1008, rear frame support 1010, solar absorber textile retainer lip 1019, and in FIG. 12A the collector joinder side 1004 with breather holes 1003. In FIG. 12B the collector end side 1020 is shown.

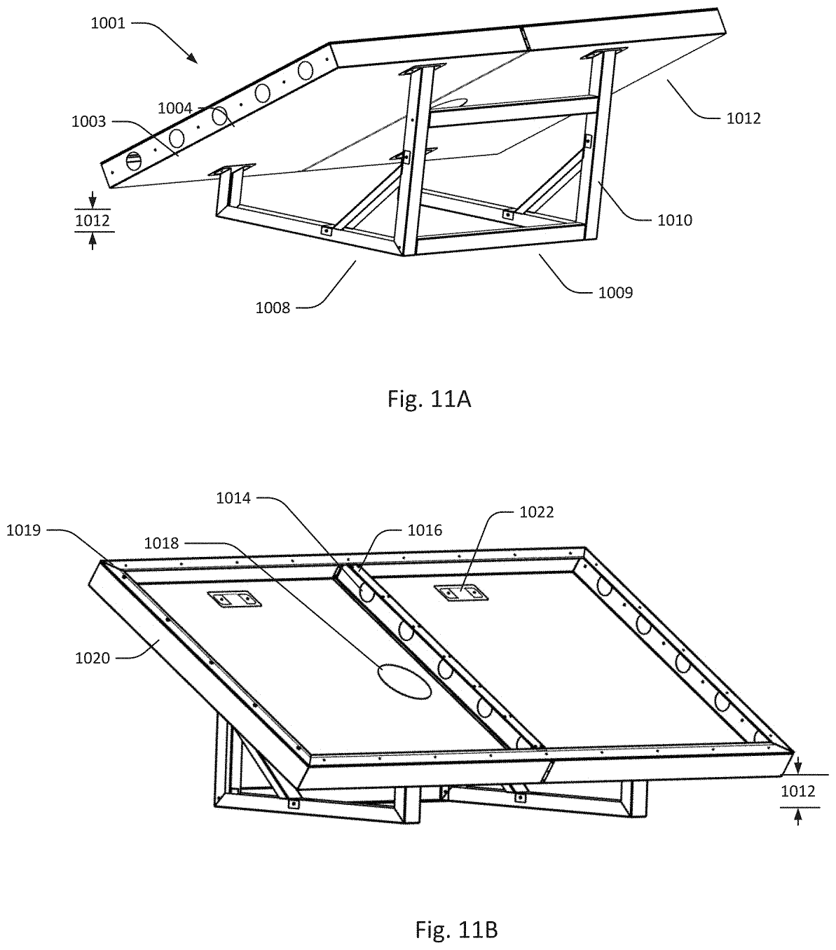

FIGS. 13A-B show back and front elevation views of this collector 1001 embodiment which include the shown components collector back panel 1012, duct outlet 1018, solar absorber retaining lip 1019, center support brace 1016 and frame supports 1010 and 1009.

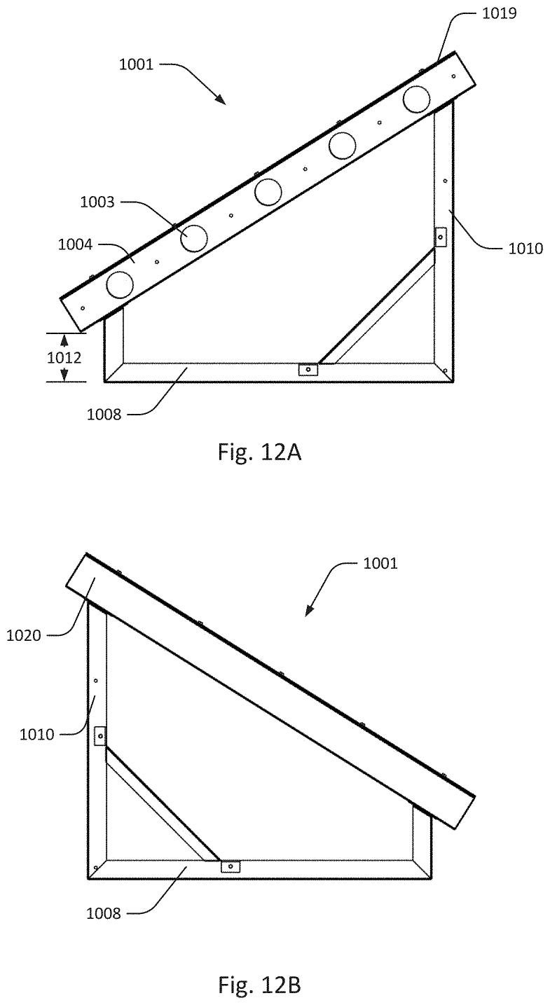

FIG. 14 shows a close-up of the collector frame joint side 1003 with breather holes 1004 and solar absorber retaining lip 1019.

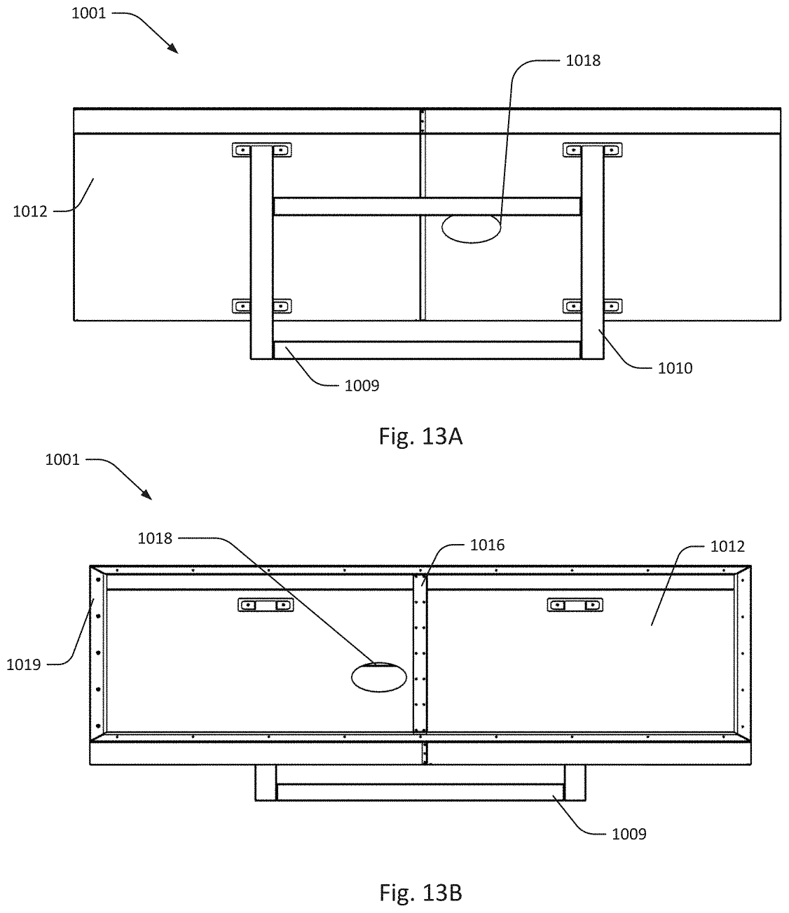

FIG. 15 shows a photograph close-up of an exemplar embodiment geotextile 1022 which is a woven, needle-punched polypropylene material. Through empirical test results, the unexpected result was obtained that geotextile fabrics of weight 5 oz per sq. yard were best suited for balancing the factors of durability, permeability and solar thermal absorbance. To configure the collector for more durability in certain applications, optionally the embodiment geotextile is non-woven propylene needle-punched material over 5 oz per square yard.

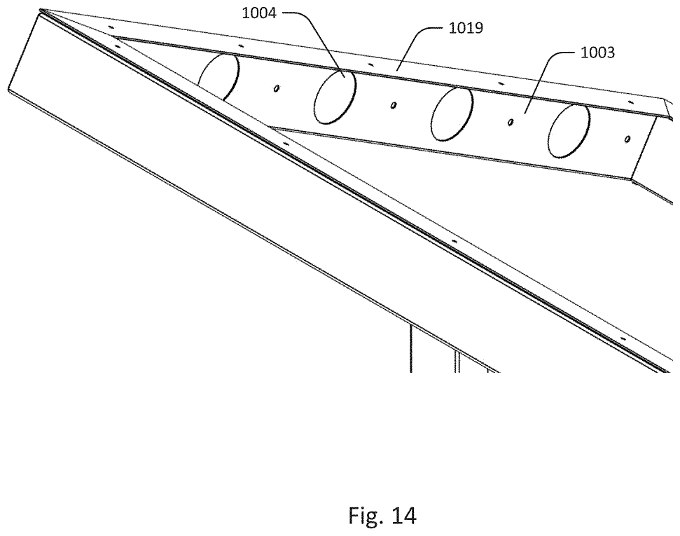

Shown in FIG. 16 is a simplified cross-section diagram of the embodiment including a collector 1001 connected to the livestock house 1030 by ducting 1024 and anchored with augers fastened to the collector frame support.

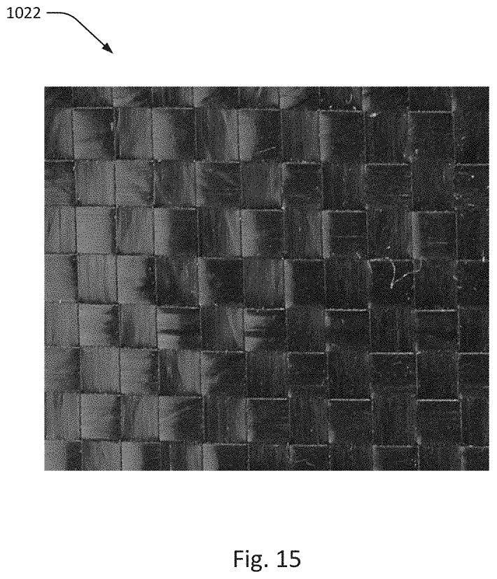

A more detailed cross section of the collector/EOS system embodiment is shown in FIG. 17, which includes the collector 1001 and livestock (poultry) house 1030 with associated interior 1036 and exterior sensors 1032 1033. Live video 1038 is provided for monitoring behavior and can be used for digital video processing to determine livestock 1042 motion patterns that indicate stress as detailed above. Video and sensors are also used in zone configurations as detailed and shown below. In various embodiments, the litter 1044 condition is monitored with sensors, including litter moisture. If the litter becomes too dry when the poultry are in the livestock structure, dust can be formed from the litter which is hazardous to poultry health. In certain embodiments, the solar thermal heating may be adjusted or turned off to prevent further litter dry out. In other embodiments, water or mist sprayers located above the litter in the livestock structure may be turned on to add clean moisture to the litter, essentially washing ammonia from the litter during operation. If the moisture is too high in the litter, excess ammonia may be indicated, a condition known to be detrimental to poultry growth and health. In such a condition, a combination of additional heat and/or clean water may be added by controlling the collector input to the livestock structure. In optional configurations, the interior sensor nest 1036 is suspended above the livestock and may be raised and lowered to maintain proximity to the livestock to record more accurate metrics of livestock conditions and behavior.

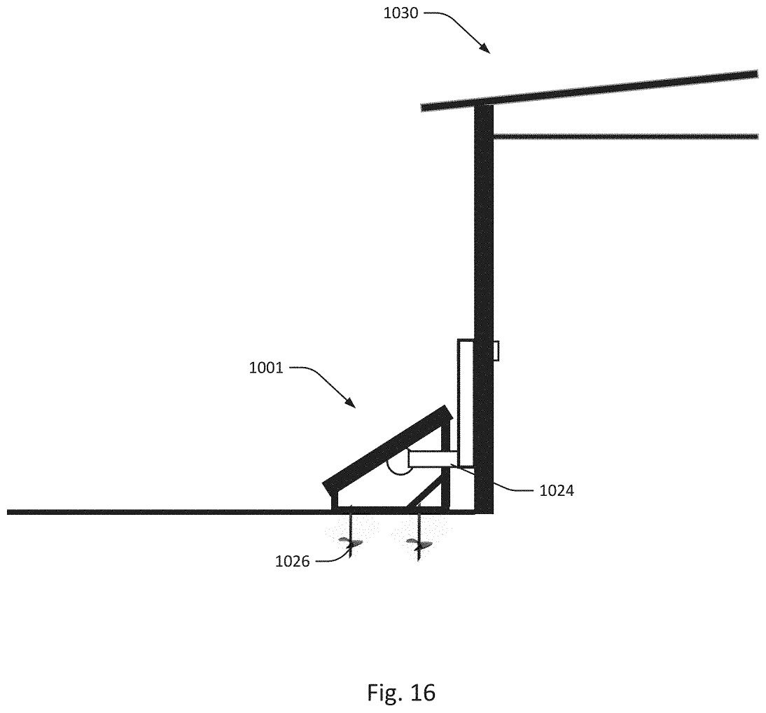

In an alternative embodiment of the system developed for poultry livestock, the livestock house is divided into zones. During the life cycle for broiler poultry, the young chicks are often grouped into a single end of a poultry house. As the chicks grow, the area of the house made available to them is expanded until the full house is utilized. FIGS. 18A-B depict diagrams of how EOS may be deployed in a livestock house 1030 zone configuration. Shown in FIG. 18A are 4 zones 1044 1045 1046 1047 of a livestock house with the prospective dividing lines between zones 1 and 2 1044A and zones 2 and 3 1045A shown. EOS sensors are shown for interior nest groups in each zone.

In FIG. 18B, prospective dimensions for one embodiment of a poultry livestock house is shown for a single house with zone 1 1044 and zone 2 1045 shown with divider lines 1044A and 1045A.

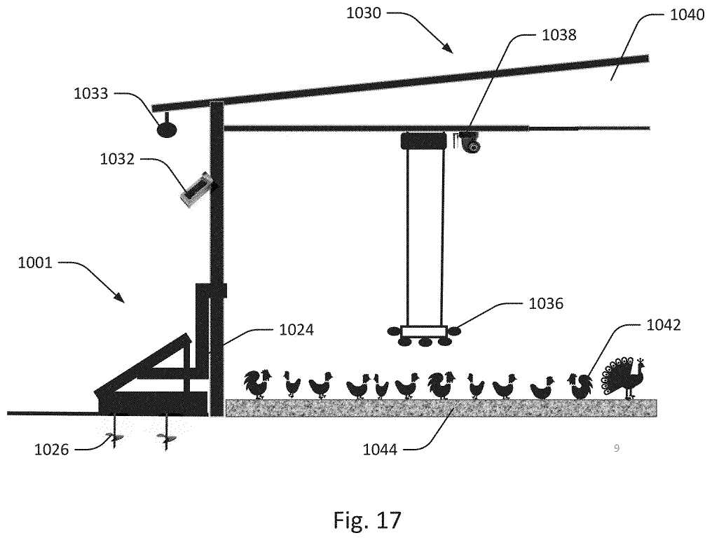

FIG. 19A-B show a diagram for deployment of EOS with a 4 unit group of joined collectors. In FIG. 19A during the initial poultry growth period, the livestock is confined to zone 1 1044 by the dividing wall 1044B. The grouped collectors 1001A-D (joined by either or breather hole connections and/or ducting) divert all the transpired heated air to the first zone, which increases the efficiency and concentration of the heated air during the most vulnerable period of livestock growth.

In FIG. 19B during the second poultry growth period, the livestock divider wall or curtain is moved from the first zone divider 1044A to the second divider wall/curtain 1045B. Thus the livestock confinement area is expanded to zones 1 1044 and 2 1045. The grouped collectors 1001A-D (joined by either or breather hole connections and/or ducting) divert the transpired heated air to the first and second zones, which increases the efficiency and concentration of the heated air during the second period of livestock growth.

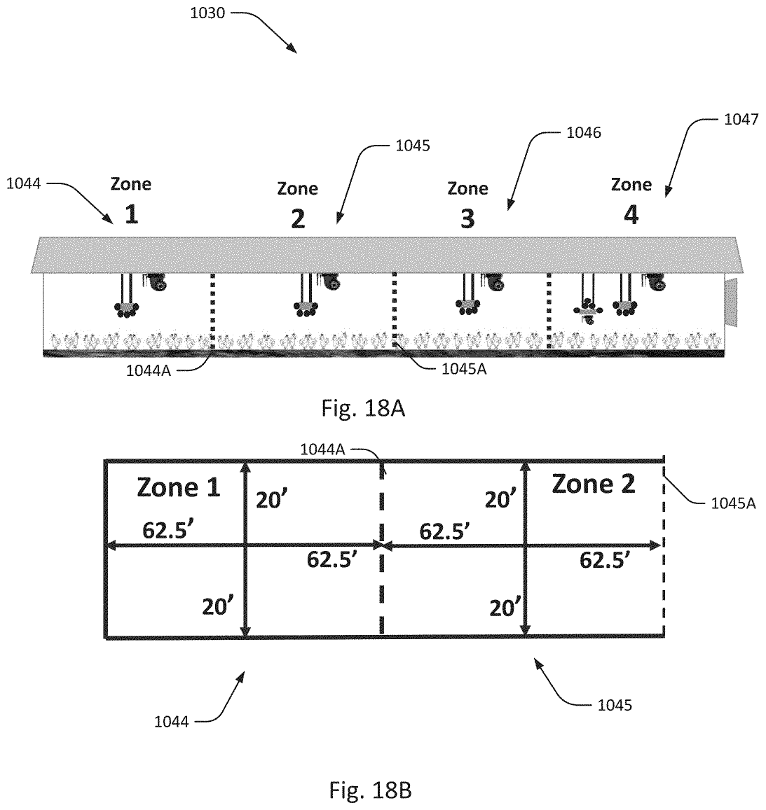

FIG. 20 shows a sensor component diagram of an expanded EOS system with livestock zone support. In each zone of the livestock house, sensors are chosen for particular applications 2001. Optional sensors include interior temperature 2002, ammonia 2003, humidity 2015, CO₂ 2017, litter condition 2019, sound 2021, motion 2023 and video 2025. In the shown embodiment sensors are grouped into zones 1-4 2005 2009 2011 2013. Video is controllable by a user for full 360-degree coverage by a remotely operated camera 2025A. The system also includes input for exterior sensors including exterior temperature 2007 and sunlight intensity 2027. Sensor inputs are sent through the Internet (cloud) to the EOS central processing and database 2045, so that the system is able to provide real-time control of collector dampers (ducting) 2031 and fans 2029 as well as operator alerts for high or low levels for temperature 2049, ammonia 2047, humidity 2051, litter condition 2053, CO₂ 2039, motion 2041 and sound 2043. Alerts and fan/damper controls are processed through a rules engine 2035 or alternatively by manual control 2037. Operators can monitor the EOS system and sensors for both multi-zone and multi-house configurations 2033 2034.

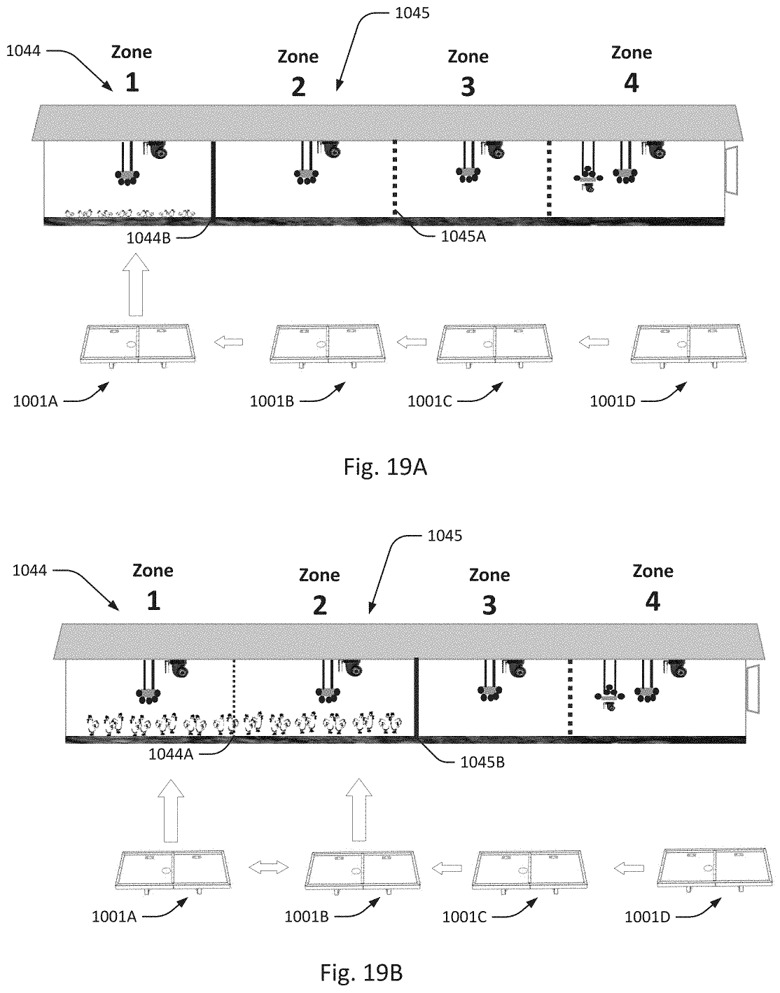

FIG. 21 presents a high-level diagram of how the EOS system sensor 2061 and components interact through an integrated connection 2063 2067 through the internet to provide capabilities for analytics 2071, a database 2070, collector and HVAC controls 2069 and live video 2065 as integrated for a zone configuration for operation 2073.

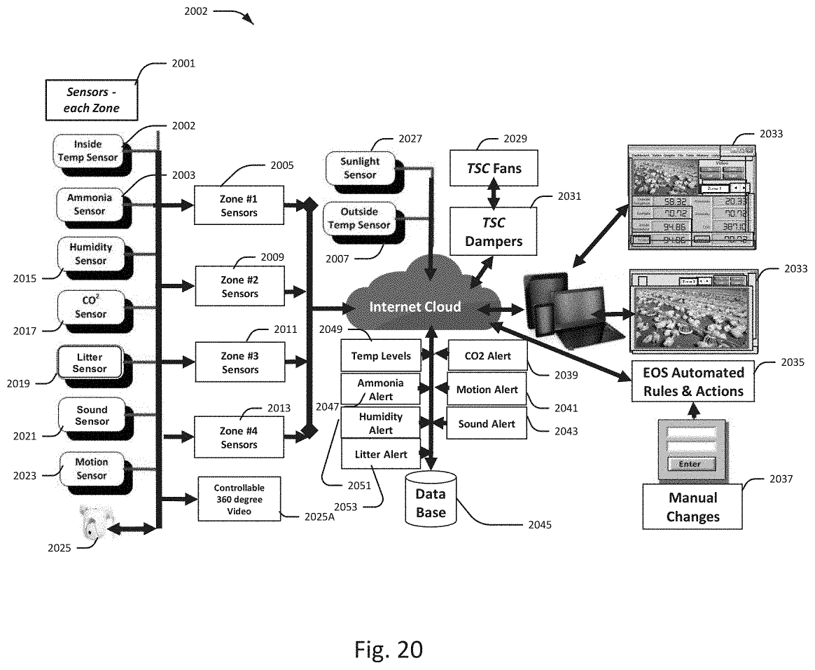

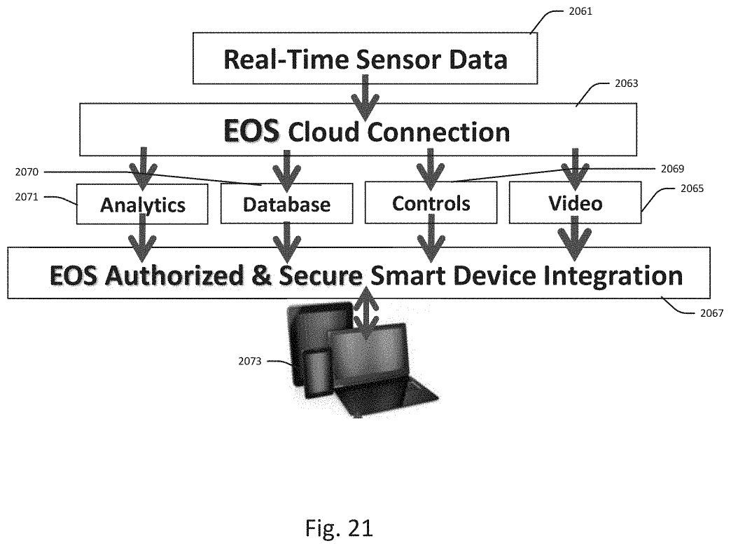

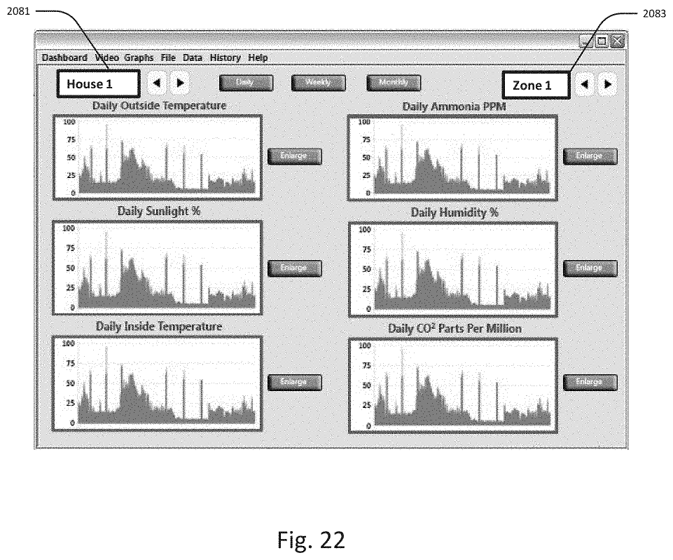

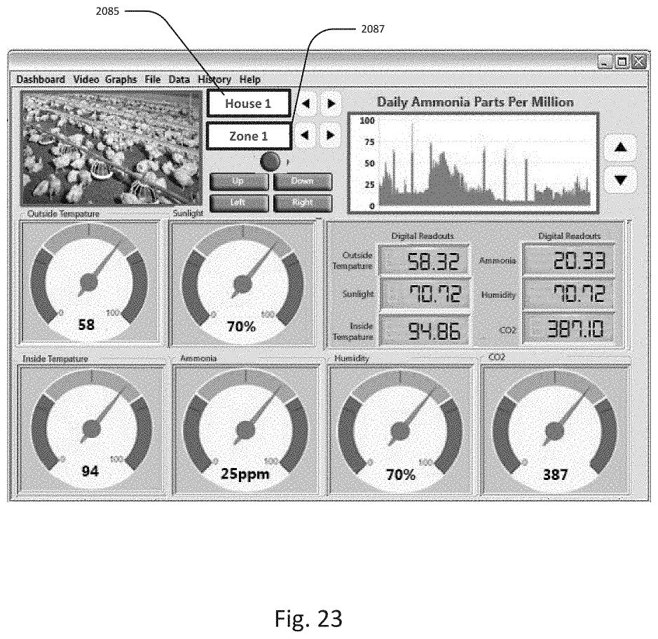

FIGS. 22-25 show operator user interfaces for the EOS zone configuration embodiment. Generally, the system interface operates as software as a service (SaaS) to provide operators real-time capabilities for sensor operation and system damper and fan controls. In this embodiment of the system, the user interface allows for monitoring of individual houses and zones. FIG. 22 shows graphs of sensor output for a chosen house 2081 and zone 2083. FIG. 23 shows real-time gauge monitoring and video for a chosen house 2085 and zone 2087. FIG. 24 shows the zone video monitoring 2091 output on a single screen interface for an individual house 2093 with 4 zones. A full screen video for a chosen house 2095 and zone 2097 is shown in FIG. 25.

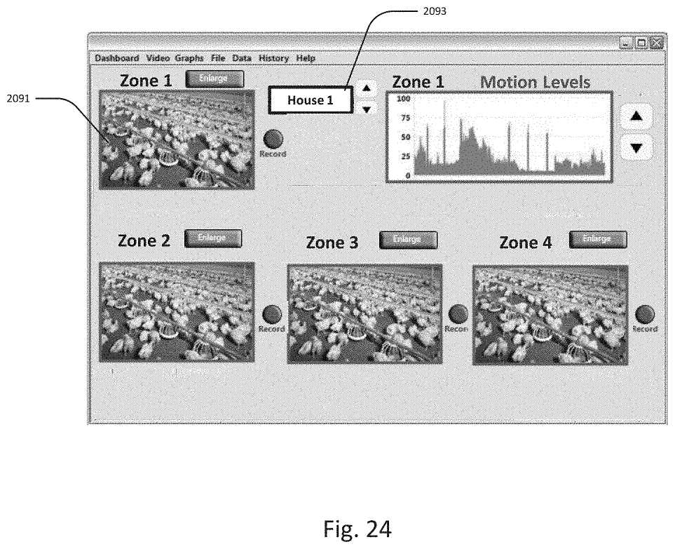

A cross-section diagram of the collector 1001 and ducting 1024 is shown in FIG. 26. In this configuration, dampers 2105 and fans 2103 from individual or groups of collectors 1001 are shown. Ducting from adjacent collectors or air flow from breather holes from joined collectors is routed by damper control. Based on empirical results and application configurations for poultry species, the poultry house collector forced air duct enters the house at a configured height 2100.

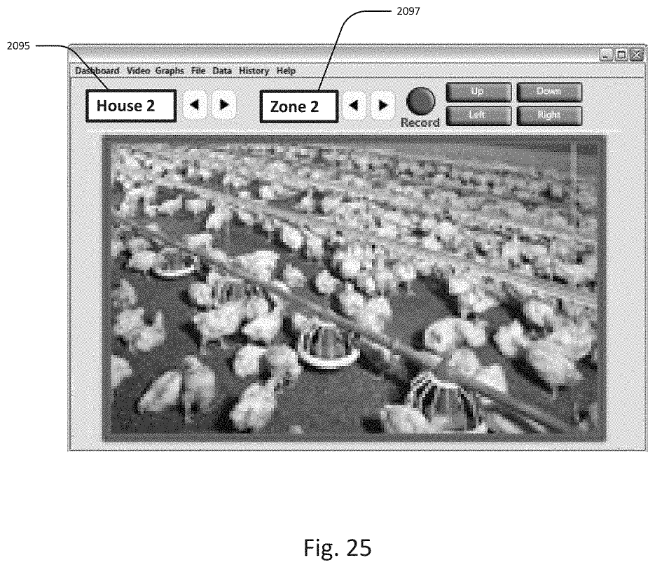

FIG. 27 shows a back-perspective view of a 4 collector unit with full 8′ HVAC ducting from each individual collectors 1001A-D connected to a central damper and fan duct connection 1024 to the poultry house zone.

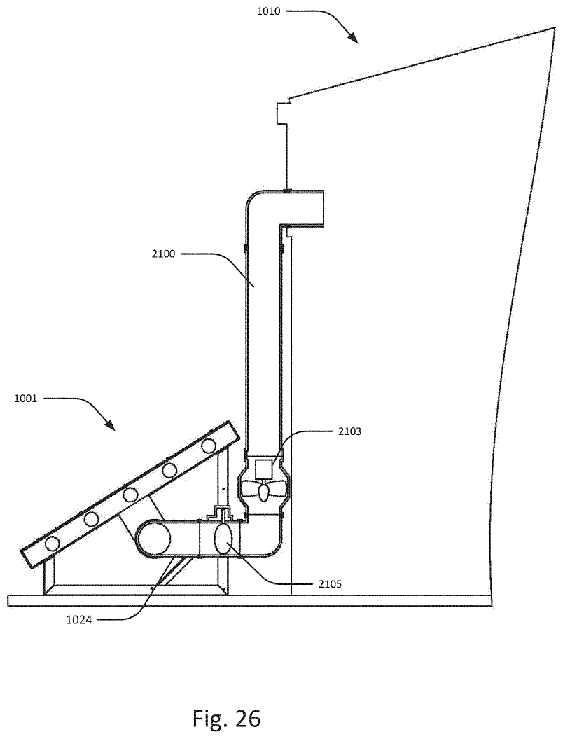

FIG. 28 shows a perspective view of the collector group how the retaining frame 1002 fits over the solar absorbing geotextile fabric 1003 for individual collectors 1001A-C which connect to the livestock house 1030 through ducting 1024.

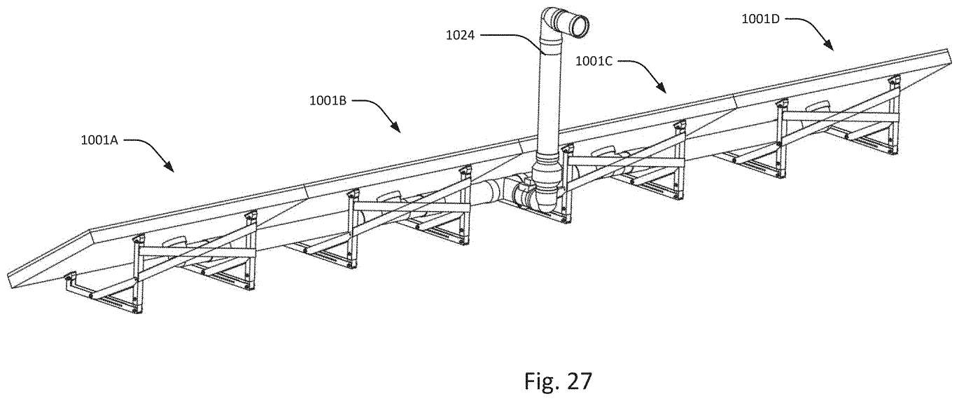

FIG. 29 shows an alternative configuration of the collector embodiment. In this configuration, the orientation of the collector 3001 is in vertical or portrait position. When deployed in this configuration, the collector solar absorbing area is doubled for a given horizontal length of the collector base. In certain applications, such as those at higher latitudes and otherwise colder climates, this orientation of the collector provides additional heat capacity for the system.

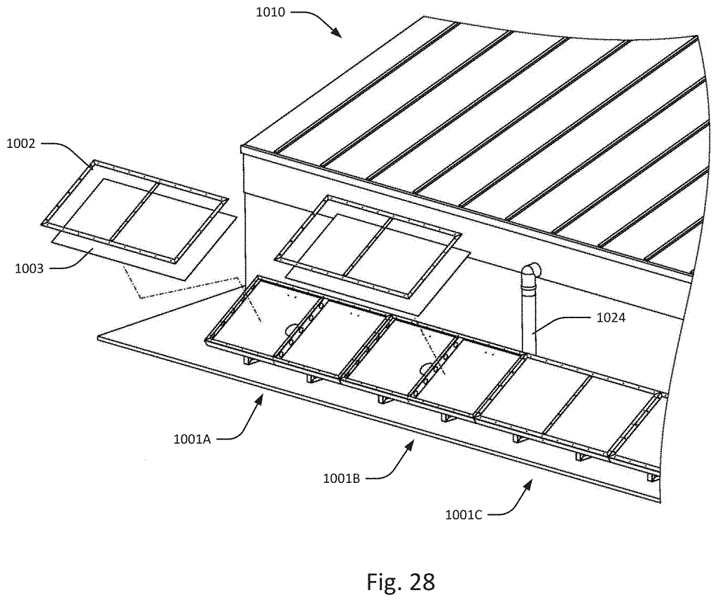

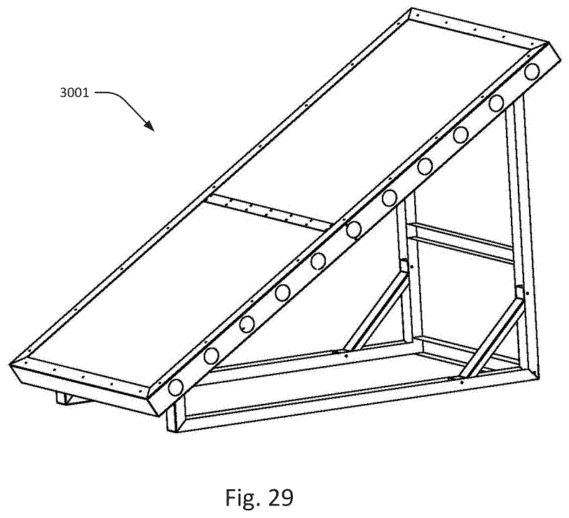

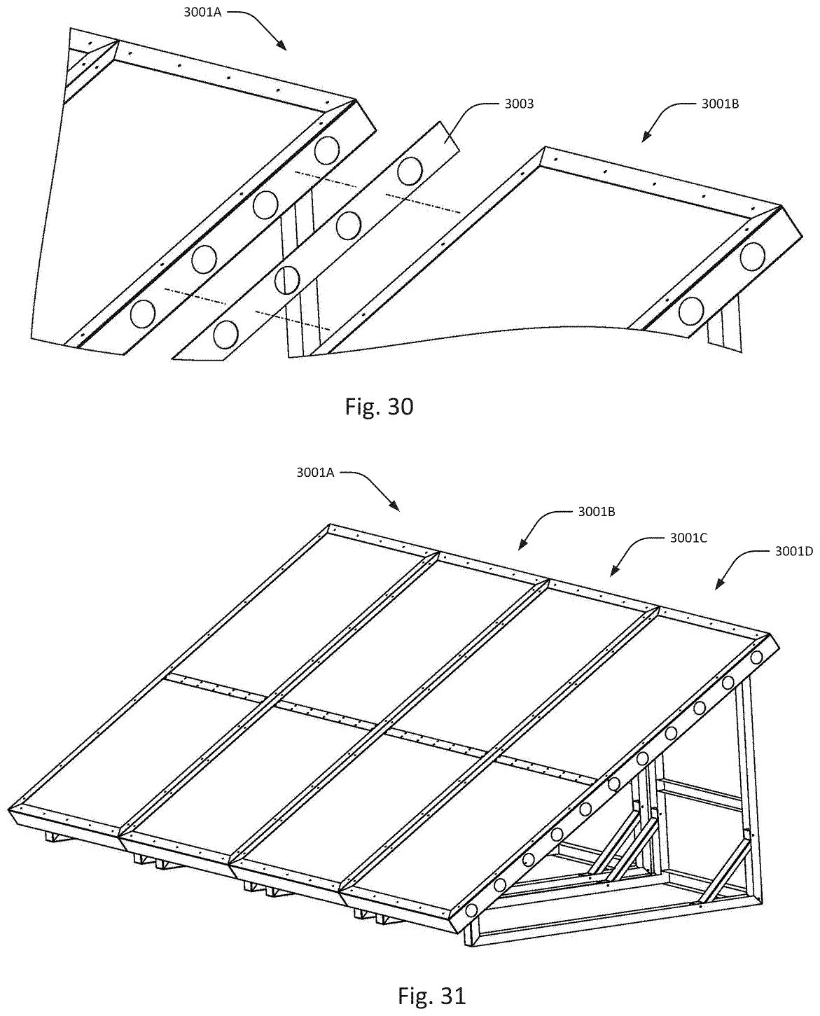

FIG. 30 shows an exemplar joint between adjacent collectors 3001A and 3001B. Adjacent collectors are joined with a 1/16″ gasket 3003 which improves the seal between collectors while permitting the free flow of air between collectors. In the vertical configuration, air flow between adjacent collectors has double the breather hole opening area, limiting the need for rear HVAC ducting within groups of collectors. FIG. 31 shows a group of 4 joined collectors in vertical orientation 3001A-D. FIG. 32 shows a livestock house with 4 groups of 4 collectors 3001 each in vertical orientation.

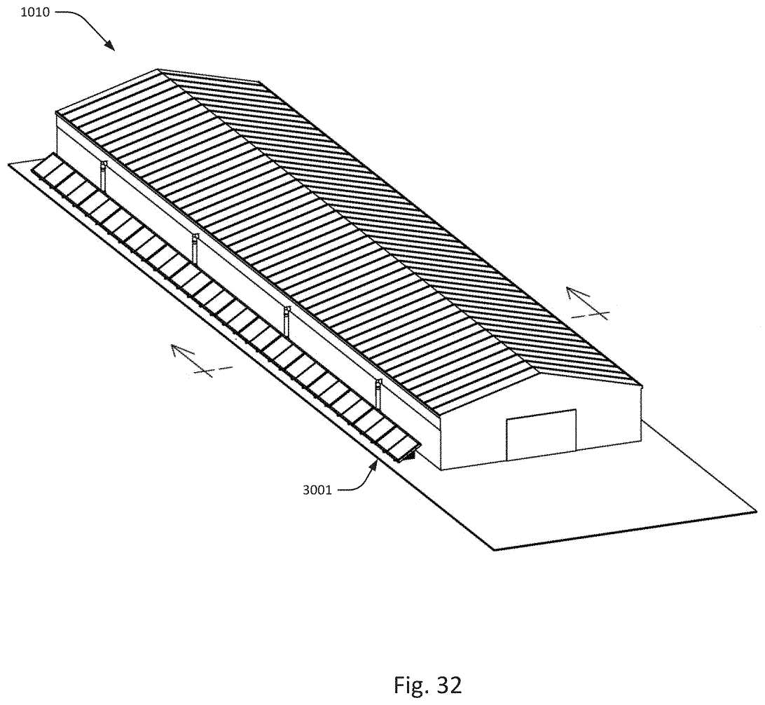

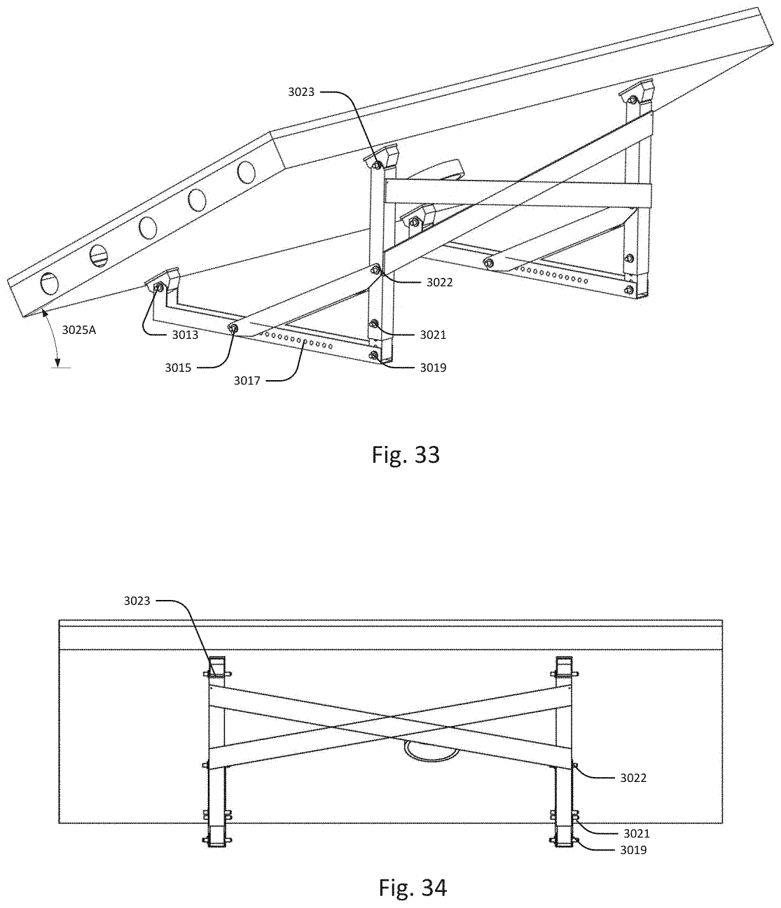

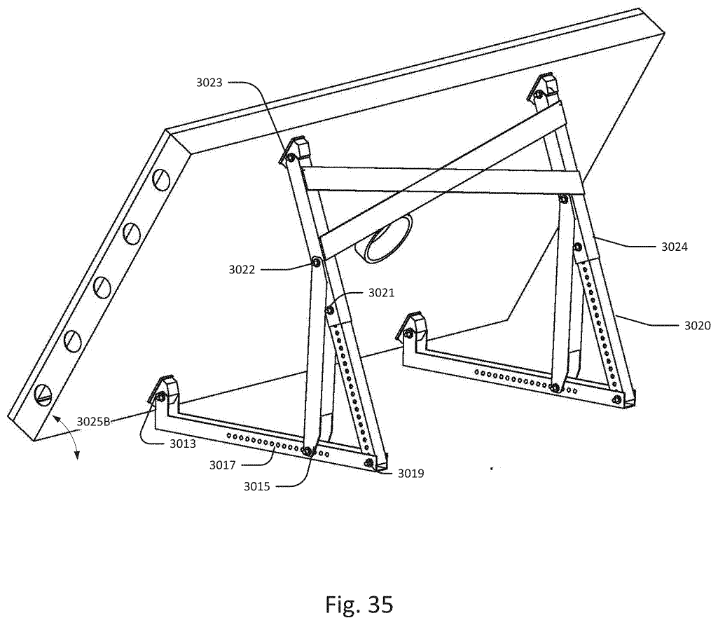

Additional embodiments of the collectors allow an adjustable single tilt axis for the collector by the installer of operator of the EOS system. Details of a single axis tilt adjustable embodiment are shown in FIGS. 33-36. FIG. 33 shows a back-perspective view of an adjustable embodiment, including the pivot points 3013 3023 3019, telescoping support brace segments 3022 3024, and tilt adjustment brace points 3017. When the telescoping vertical brace components 3024 and 3020 are release to slide vertically by removing adjustment fasteners 3015 and 3023, new vertical and base adjustment points can be chosen and the fasteners replaced to achieve the desired tilt angle 3025A of the collector, The tilt axis is chosen at the from or lower pivot point 3013 so that the front collector edge remains at approximately the same distance from the ground, maintaining the configuration storm clearance. FIG. 34 shows the back view of this embodiment of the collector in the same configured tilt angle. FIG. 35 shows the same single axis tilt adjustable embodiment configured for a greater tilt angle 3025B. To adjust the tilt angle as shown, the telescoping sections 3020 and 3022 are moved apart vertically and adjustment fasteners 3015 3021 are replaced into the base and vertical corresponding positions fixing the tilt angle. Pivot points 3013 3019 3023 adjust accordingly. In other operator/installer tilt adjustable embodiments, the tilt position is adjusted with a single central support for each collector.

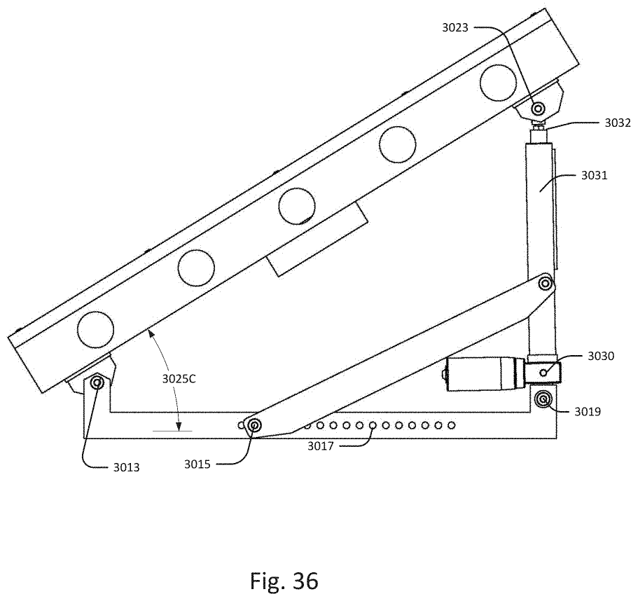

In various embodiments, the tilt angle is adjusted dynamically according to time of year, where the optimal angle ranges from its minimal value (with the sun in the highest position above the horizon) at the summer solstice to its maximum value (with the sun at the lowest position above the horizon) at the winter solstice. In other embodiments, the tilt angle is adjusted dynamically according to the real-time position of the sun overhead. In certain embodiments, both the overhead angle and angle with respect to the horizon are dynamically adjustable. Such an embodiment implements 2 tilt axes for tracking the solar incident angle. Since efficiency of solar absorption drops off substantially near sunrise and sunset, the tilt angle range may be limited to an efficiency range. FIG. 36 shows a side view of a single tilt axis dynamically adjustable embodiment. In this embodiment, the same pivot points are used as in the above disclosed version 3013 3019 3023. In place of the fixable telescoping vertical brace, a linear actuator 3031 is used, which is attached to the support frame at upper 3032 and lower 3030 fastener locations. The collector is configurable for different vertical ranges by changing the linear actuator and adjusting the brace position 3015 3017. In various embodiments, the linear actuators for a group of collectors are synchronized by EOS to dynamically change the collector tilt for each collector in a group single linear actuator support can be used to track the sun position above the southern horizon (for northern hemisphere installations) by adjusting the position in small daily increments, minimizing any torsional forces on the collector group caused by actuator synchronization issues. Embodiments which use a dynamically adjusting tilt mechanism also implement flexible HVAC ducting to maintain the system integrity and minimize thermal leakage.

The implications of the present invention's numerous potential configurations and embodiments are far reaching. Other embodiments include any livestock housing, grow houses for tropical plants, germination, or out of season cultivation, or as an energy saving system for human inhabited structures. The economic savings provided by the use of optimized thermal collection are widely applicable and available by only small changes to presented embodiments.

In the various described and other embodiments, use of a sustainable energy source provides significant savings in energy, including the energy usage per production pound of livestock. Additionally, various embodiments reduce polluting emissions from the facility, including CO₂ and ammonia.

The routines and/or instructions that may be executed by the one or more processing units to implement embodiments of the invention, whether implemented as part of an operating system or a specific application, component, program, object, module, or sequence of operations executed by each processing unit, will be referred to herein as “program modules”, “computer program code” or simply “modules” or “program code.” Generally, program modules may include routines, programs, objects, components, logic, data structures, and so on that perform particular tasks or implement particular abstract data types. Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. Given the many ways in which computer code may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The flowcharts, block diagrams, and sequence diagrams herein illustrate the architecture, functionality, and operation of possible implementations of systems, methods, and computer program products according to various embodiments of the present invention. In this regard, each block in a flowchart, block diagram, or sequence diagram may represent a segment or portion of program code, which comprises one or more executable instructions for implementing the specified logical function(s) and/or act(s). Program code may be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the blocks of the flowcharts, sequence diagrams, and/or block diagrams herein. In certain alternative implementations, the functions noted in the blocks may occur in a different order than shown and described. For example, a pair of blocks described and shown as consecutively executed may be instead executed concurrently, or the two blocks may sometimes be executed in the reverse order, depending upon the functionality involved. Each block and combinations of blocks can be implemented by special purpose hardware-based systems that perform the specified functions or acts, or combinations of special purpose hardware and computer instructions.

The program code embodied in any of the applications described herein is capable of being individually or collectively distributed as a program product in a variety of different forms. In particular, the program code may be distributed using a computer readable media, which may include computer readable storage media and communication media. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

Although the invention has been described in terms of the preferred and exemplary embodiments, one skilled in the art will recognize many embodiments not mentioned here by the discussion and drawing of the invention. Interpretation should not be limited to those embodiments specifically described in this specification.

I claim:

1. A solar thermal collector heating system for a poultry livestock structure comprising:
at least one solar thermal collector comprising:
a collector housing wherein the collector housing comprises an open cuboid form sized at least 3 feet wide, at least 3 feet long, and less than 5 inches deep;
a solar absorbing geotextile cover of the collector housing, wherein the solar absorbing geotextile cover comprises a needle-punched polypropylene material with a textile weight of at least 5 ounces per square feet;
a collector support structure, wherein the support structure is configurable to be positioned at a tilt angle relative to level ground;
an HVAC controller unit;
at least one controllable fan;
at least one controllable damper wherein the at least one controllable fan and the at least one controllable damper are configured to controllably draw air through the solar absorbing geotextile cover into the interior of the poultry livestock structure.

2. The solar thermal collector heating system of claim 1 wherein at least one side of the at least one collector housing comprises a plurality of breather holes wherein the breather holes are sized to be a diameter greater than one half the depth of the at least one collector housing;
wherein at least two adjacent solar thermal collectors are joined together wherein identical breather holes on corresponding sides of the at least two adjacent solar thermal collectors positioned with mating breather hole openings providing a free flow of air between interiors of the at least two adjacent solar thermal collectors.

3. The solar thermal collector heating system of claim 2 also comprising at least one breather hole gasket positioned between the at least two joined collectors.

4. The solar thermal collector heating system of claim 3 wherein the breather hole gasket comprises a deformable elastomer.

5. The solar thermal collector heating system of claim 2 where at least three solar thermal collectors are joined together in a collector group with at least two of the solar thermal collectors being collector end units comprising a plurality of breather holes on one side of each collector end unit, and at least one of the solar thermal collectors being a collector middle unit comprising a plurality of breather holes on 2 opposite sides of each collector middle unit.

6. The solar thermal collector heating system of claim 1 wherein the solar absorbing geotextile cover is woven.

7. The solar thermal collector heating system of claim 5 wherein for each collector group, air is drawn into the poultry livestock structure through the solar absorbing geotextile covers of each collector in each group through a single controllable fan.

8. The solar thermal collector heating system of claim 1 also comprising a litter condition sensor.

9. The solar thermal collector heating system of claim 1 wherein the poultry livestock structure is divided into a plurality of zones.

10. The solar thermal collector heating system of claim 9 wherein for each of the zones, at least one controllable fan draws air into the interior of the poultry livestock structure corresponding to a respective zone through a respective collector group.

11. The solar thermal collector heating system of claim 9, wherein according to system input the HVAC controller unit directs the at least one controllable fan and the at least one controllable damper to route air flow drawn through the solar thermal collector heating system into the poultry livestock structure into at least one zone.

12. The solar thermal collector heating system of claim 11, wherein according to system input the HVAC controller unit directs the at least one controllable fan and the at least one controllable damper to route air flow drawn through the solar thermal collector heating system from a plurality of collector groups into a fewer than a total number of zones of the poultry livestock structure interior.

13. The solar thermal collector heating system of claim 1 wherein the tilt angle relative to the ground is configurable at or after installation of the solar thermal collector heating system.

14. The solar thermal collector heating system of claim 1 wherein the tilt angle relative to the ground is adjustable dynamically during operation.

15. The solar thermal collector heating system of claim 14 according to the position of the sun above the horizon at an installation location on a given date.

16. A solar thermal collector comprising:
a collector housing wherein the collector housing comprises an open cuboid form sized at least 3 feet wide, at least 3 feet long, and less than 5 inches deep;
a solar absorbing geotextile cover of the collector housing, wherein the solar absorbing geotextile cover comprises a needle-punched polypropylene material with a textile weight of at least 5 ounces per square feet;
a collector support structure, wherein the support structure is configurable to be positioned at a tilt angle relative to level ground.

17. The solar thermal collector of claim 16 also comprising at least one interior support brace positioned in parallel to and midway between a left side edge and a right side edge wherein the interior support brace comprises a plurality of breather holes wherein the breather holes are sized to be a diameter greater than one half the depth of the collector housing;
whereby the breather holes allow for free air flow between collector chambers defined by the at least one interior support brace.

18. The solar thermal collector of claim 16 wherein the solar absorbing geotextile material is woven.

19. The solar thermal collector of claim 16 wherein one or more lateral edges of the collector housing comprises a plurality of breather holes wherein the breather holes are sized to be a diameter greater than one half the depth of the collector housing;
whereby the breather holes allow for free air flow from the solar thermal collector to adjacent connected solar thermal collectors.

20. A method for zone-based heating of an interior of a poultry livestock structure using an array of connected groups of solar thermal absorbing collectors, wherein each of the solar thermal collectors comprise an open cuboid housing sized at a width to depth ratio of at least 10:1 and a length to depth ratio of least 10:1, wherein the open cuboid housing is covered with a solar absorbing geotextile, wherein the array of connected groups is connected to the poultry livestock structure by HVAC ducting comprising at least on controllable fan and at least one controllable fan for each connected group, comprising the steps of:
activating heated air induction by opening at least one damper and activating at least one inline fan between the array of connected collector groups, wherein individual solar thermal collectors in each group are connected with pairs of mating edges of adjacent joined collectors, the pairs of mating edges each comprising a plurality of breather holes sized with a diameter of at least one half the depth of the collector housing;
controlling the output of each of the collector groups with at least one controllable fan and at least on controllable damper by damping air flow to interior zones of the poultry livestock structure, directing heated air flow to interior zones determined to need additional heat according to processing of acquired sensor readings from the interior zones and according to the poultry life-cycle optimal conditions for poultry livestock in each zone.
